(19) United States
(12) Patent Application Publication
(10) Pub. No.: US 2019/0289101 A1
(43) Pub. Date: Sep. 19, 2019

(54) INFORMATION PROCESSING APPARATUS AND METHOD OF DETECTING PACKET

(71) Applicant: FUJITSU LIMITED, Kawasaki-shi (JP)

(72) Inventors: Fumiyuki Iizuka, Kawasaki (JP); Ken Yokoyama, Kawasaki (JP)

(73) Assignee: FUJITSU LIMITED, Kawasaki-shi (JP)

(21) Appl. No.: 16/276,670

(22) Filed: Feb. 15, 2019

(30) Foreign Application Priority Data
Mar. 19, 2018 (JP) 2018-051060

(51) Int. Cl. H04L 29/06; H04L 12/26; H04L 12/823

(52) U.S. Cl. CPC H04L 69/166; H04L 47/32; H04L 69/22; H04L 43/04

(57) ABSTRACT

An information processing apparatus includes a processor configured to identify, upon acquiring a communication packet, a communication session based on information included in a header of the acquired communication packet. The processor is configured to determine whether first management information includes first acquisition information indicating that a communication packet corresponding to a packet identifier included in a header of the acquired communication packet has been acquired. The processor is configured to determine, upon determining that the first management information includes the first acquisition information, whether second management information includes second acquisition information indicating that a communication packet corresponding to a fragment offset included in a header of the acquired communication packet has been acquired. The processor is configured to discard the acquired communication packet upon determining that the second management information includes the second acquisition information.

### CROSS-REFERENCE TO RELATED APPLICATION

This application is based upon and claims the benefit of priority of the prior Japanese Patent Application No. 2018-051060, filed on Mar. 19, 2018, the entire contents of which are incorporated herein by reference.

### FIELD

The embodiments discussed herein are related to an information processing apparatus and a method of detecting a packet.

### BACKGROUND

A business operator who provides a user with a service (hereinafter, also simply referred-to as an “operator”) constructs and operates a work system that performs a process for providing the service (hereinafter, also referred-to as an “information processing system”). Then, for example, the operator acquires and analyzes a communication packet (hereinafter, also simply referred-to as a “packet”) flowing through a network constituting the work system, so as to confirm the operation state of the work system. Specifically, for example, the operator installs capturing points at multiple locations through which communication packets to be analyzed pass, and acquires communication packets flowing through the network, so as to confirm the operation state of the work system.

Here, the communication packets flowing through the network constituting the work system may include a communication packet passing through multiple capturing points according to, for example, the configuration of the network. Thus, in order to accurately identify the number of communication packets flowing through the network, the operator conducts a duplication check of each communication packet acquired at the capturing points.

Related techniques are disclosed in, for example, Japanese National Publication of International Patent Application No. 2014-510504.

The duplication check of a communication packet described above is performed by determining, for example, when a new communication packet is acquired at a capturing point, whether the same packet as the acquired communication packet was acquired in the past. Then, when it is determined that the same packet as the new communication packet was acquired in the past, the operator determines that the new communication packet is a duplicate packet, and discards the duplicate packet.

However, the duplication check of a communication packet is performed by, for example, matching the entire data included in the acquired communication packet with the entire data included in the communication packet that have been acquired in the past. Thus, when the number of communication packets that need to be matched is large, the duplication check of the communication packets causes an increase in the process load of, for example, a CPU.

### SUMMARY

According to an aspect of the present invention, provided is an information processing apparatus including a first memory, a second memory, and a processor coupled to the first and second memories. The first memory is configured to store, for each communication session, first management information indicating whether a communication packet corresponding to a packet identifier has been acquired. The second memory is configured to store, for each combination of a communication session and a packet identifier, second management information indicating whether a communication packet corresponding to a fragment offset has been acquired. The processor is configured to identify, upon acquiring a communication packet, a communication session in which the acquired communication packet is transmitted and received, based on information included in a header of the acquired communication packet. The processor is configured to determine whether the first management information stored in the first memory includes first acquisition information indicating that a communication packet corresponding to a packet identifier included in a header of the acquired communication packet has been acquired. The processor is configured to determine, upon determining that the first management information includes the first acquisition information, whether the second management information stored in the second memory includes second acquisition information indicating that a communication packet corresponding to a fragment offset included in a header of the acquired communication packet has been acquired. The processor is configured to discard the acquired communication packet upon determining that the second management information includes the second acquisition information. The processor is configured to add acquisition information indicating that the acquired communication packet has been acquired to the first management information and the second management information upon determining that the first management information does not include the first acquisition information or upon determining that the second management information does not include the second acquisition information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration of an information processing system;

FIG. 2 is a view for explaining a relationship between a duplicate packet detecting apparatus and capturing points;

FIG. 3 is a diagram illustrating a hardware configuration of the duplicate packet detecting apparatus;

FIG. 4 is a block diagram of a function of the duplicate packet detecting apparatus;

FIG. 5 is a flowchart for explaining an outline of a packet detecting process according to a first embodiment;

FIG. 6 is a flowchart for explaining the outline of the packet detecting process according to the first embodiment;

FIG. 7 is a flowchart for explaining details of the packet detecting process according to the first embodiment;

FIG. 8 is a flowchart for explaining the details of the packet detecting process according to the first embodiment;

FIG. 9 is a flowchart for explaining the details of the packet detecting process according to the first embodiment;

FIG. 10 is a flowchart for explaining the details of the packet detecting process according to the first embodiment;

FIG. 11 is a flowchart for explaining the details of the packet detecting process according to the first embodiment;

FIG. 12 is a flowchart for explaining the details of the packet detecting process according to the first embodiment;

FIGS. 13A and 13B are diagrams illustrating a configuration of a communication packet (IP packet);

FIG. 14 is a view for explaining a specific example of session information;

FIG. 15 is a view for explaining a specific example of first management information;

FIG. 16 is a view for explaining a specific example of storage location information;

FIG. 17 is a view for explaining the specific example of the storage location information;

FIG. 18 is a view for explaining a specific example of second management information;

FIGS. 19A and 19B are views illustrating a specific example of initialization management information;

FIGS. 20A and 20B are views illustrating the specific example of the initialization management information;

FIGS. 21A and 21B are views for explaining details of the packet detecting process according to the first embodiment;

FIGS. 22A and 22B are views illustrating the specific example of the initialization management information;

FIG. 23 is a flowchart for explaining details of a packet detecting process according to a second embodiment;

FIG. 24 is a flowchart for explaining the details of the packet detecting process according to the second embodiment;

FIG. 25 is a flowchart for explaining the details of the packet detecting process according to the second embodiment;

FIG. 26 is a flowchart for explaining the details of the packet detecting process according to the second embodiment;

FIG. 27 is a flowchart for explaining the details of the packet detecting process according to the second embodiment;

FIG. 28 is a flowchart for explaining the details of the packet detecting process according to the second embodiment;

FIG. 29 is a view for explaining a specific example of storage location information according to the second embodiment; and

FIG. 30 is a view for explaining the specific example of the storage location information according to the second embodiment.

### DESCRIPTION OF EMBODIMENTS

<Configuration of Information Processing System>

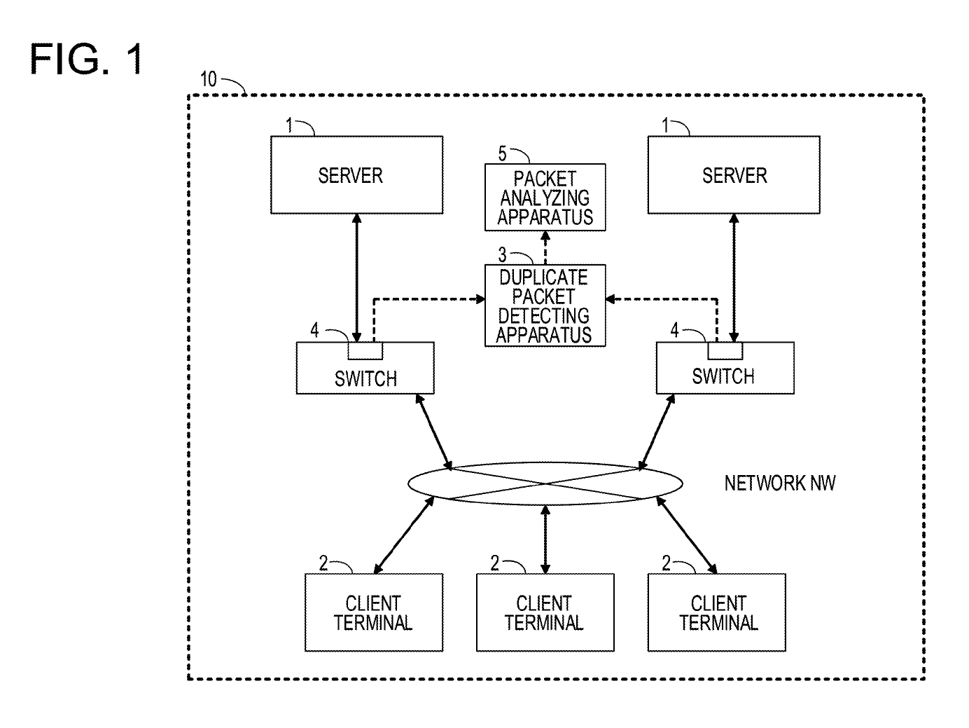

FIG. 1 is a diagram illustrating an entire configuration of an information processing system. As illustrated in FIG. 1, an information processing system 10 is provided with a server 1, a client terminal 2, a duplicate packet detecting apparatus 3 (hereinafter, also referred-to as a “packet detecting apparatus 3”), and a packet analyzing apparatus 5. The server 1 and the client terminal 2 are accessible to each other via a network NW such as the Internet or an intranet. The packet analyzing apparatus 5 is connected to a switch 4 connected to, for example, the server 1, via the duplicate packet detecting apparatus 3. In the information processing system 10 illustrated in FIG. 1, the number of servers 1 may be a number other than two. In the information processing system 10 illustrated in FIG. 1, the number of client terminals 2 may be a number other than three. In the information processing system 10 illustrated in FIG. 1, the number of switches 4 may be a number other than two.

For example, the server 1 executes a process according to a process request from the client terminal 2, and returns a result of the process to the client terminal 2.

Specifically, the process executed in the server 1 relates to, for example, managing information such as a schedule of a user input by the user from the client terminal 2, and may relate to displaying necessary information on the client terminal 2 according to a process request from the user. In addition, for example, the process executed in the server 1 relates to managing information such as schedules of multiple users input by the respective users, and may relate to displaying an integrated form of the schedules of all the users on the client terminal according to a process request from the users.

For example, the client terminal 2 transmits a process request to the server 1, and receives the result. The client terminal 2 may be, for example, a stationary terminal such as a desktop PC or a remote terminal such as a mobile phone.

The switch 4 is disposed between the server 1 and the network NW and has, for example, a mirror port (not illustrated). For example, the mirror port duplicates communication packets flowing through the network NW and outputs each of the duplicated packets. Specifically, for example, the mirror port duplicates a communication packet transmitted toward the server 1, and transmits the duplicated communication packet which is identical to the communication packet transmitted toward the server 1, to the duplicate packet detecting apparatus 3.

In addition, the information processing system 10 may include a network tap (not illustrated) which is separate from the switch 4, and duplicate a communication packet flowing through the network NW by using the network tap. Hereinafter, descriptions will be made assuming that the communication packet is an Internet protocol (IP) packet transmitted and received in the IP.

For example, the packet analyzing apparatus 5 analyzes the communication packet flowing through the network NW in order to monitor the operation state of the server 1 or the network NW. Specifically, the packet analyzing apparatus 5 analyzes, for example, the number of communication packets flowing through the network NW and an occurrence/non-occurrence of a packet loss in a unit time (analysis of layer 4 level), or a response time including an operation of an application (analysis of layer 7 level).

The duplicate packet detecting apparatus 3 acquires a communication packet to be analyzed in the packet analyzing apparatus 5 from the network NW, and transmits the acquired communication packet to the packet analyzing apparatus 5. Then, before transmitting the acquired communication packet to the packet analyzing apparatus 5, the duplicate packet detecting apparatus 3 checks the duplication of the acquired communication packet to exclude a detected duplicate packet. As a result, the packet analyzing apparatus 5 may analyze the communication packet in a state where a duplicate packet is excluded.

<Duplicate Packet Detecting Apparatus and Capturing Points>

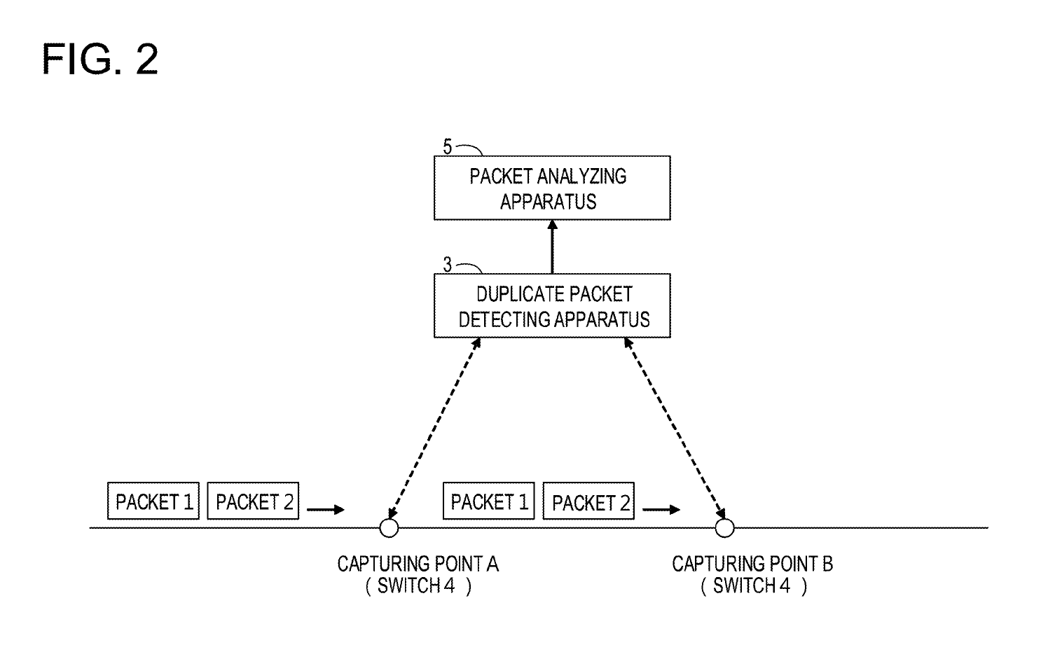

Next, the duplicate packet detecting apparatus 3 and the capturing points will be described. FIG. 2 is a view for explaining a relationship between the duplicate packet detecting apparatus 3 and the capturing points.

The respective communication packets flowing through the network NW may be transmitted through different communication paths according to, for example, a type of a service related to each communication packet. Thus, as illustrated in FIG. 2, a capturing point where a communication packet is acquired is generally installed at multiple locations (e.g., respective switches 4). As a result, the operator is able to collectively acquire communication packets which are necessary to perform the analysis.

However, in this case, there is possibility that a communication packet to be analyzed may pass through the multiple capturing points (capturing points A and B in FIG. 2) according to, for example, a path setting in a device disposed in the network NW. Thus, the packet analyzing apparatus 5 may interpret that the same communication packet has been generated multiple times.

Thus, before the acquired communication packet is transmitted to the packet analyzing apparatus 5, the duplicate packet detecting apparatus 3 checks the duplication of the acquired communication packet. As a result, the duplicate packet detecting apparatus 3 is able to transmit the communication packet to the packet analyzing apparatus 5 in a state where a duplicate packet is excluded.

Here, for example, the duplication of a communication packet is checked by matching a communication packet acquired in the past and a newly acquired communication packet with each other, when the new communication packet is acquired. Specifically, the duplicate packet detecting apparatus 3 saves all acquired communication packets, and matches a newly acquired communication packet with the stored communication packets, each time the new communication packet is acquired. Then, when it is determined that the newly acquired communication packet is identical to a stored communication packet, the duplicate packet detecting apparatus 3 determines that the newly acquired communication packet is a duplicate packet and discards the duplicate packet.

However, for example, when communication packets are transmitted and received by a high-speed communication line (e.g., a communication line with a communication speed of 10 (Gbps)), the number of communication packets that need to be matched with a newly acquired communication packet becomes huge. Thus, in this case, the duplication check of a communication packet causes the increase in the process load of, for example, the CPU of the duplicate packet detecting apparatus 3.

Thus, when a communication packet is acquired, the duplicate packet detecting apparatus 3 in the present embodiment identifies a communication session in which the acquired communication packet is transmitted and received, based on information identifying a communication session (hereinafter, also simply referred-to as a “session”) included in the header of the acquired communication packet.

Then, the duplicate packet detecting apparatus 3 refers to a memory that stores information indicating, for each communication session, whether a communication packet corresponding to a communication (IP) packet identifier for identifying each communication packet in the same session (hereinafter, also simply referred-to as an “IP identifier”) has been acquired (hereinafter, also referred-to as “first management information”), and determines whether the first management information corresponding to the identified communication session includes information indicating that a communication packet corresponding to an IP identifier of the acquired communication packet has been acquired (hereinafter, also referred-to as “first information”).

Then, when it is determined that the first management information includes the first information, the duplicate packet detecting apparatus 3 refers to the memory that stores information indicating, for each communication session and each IP identifier, whether a communication packet corresponding to each fragment offset has been acquired (hereinafter, also referred-to as “second management information”), and determines whether the second management information corresponding to a combination of the identified communication session and the IP identifier of the acquired communication packet includes information indicating that a communication packet corresponding to a fragment offset of the acquired communication packet has been acquired (hereinafter, also referred-to as “second information”).

Then, when it is determined that the second management information includes the second information, the duplicate packet detecting apparatus 3 discards the acquired communication packet, and when it is determined that the first management information does not include the first information or the second management information does not include the second information, the duplicate packet detecting apparatus 3 adds the information indicating that the acquired communication packet has been acquired, to the first management information and the second management information.

That is, the duplicate packet detecting apparatus 3 maintains the first management information indicating whether a communication packet corresponding to each IP identifier has been acquired, for each communication session, and the second management information indicating whether a communication packet corresponding to each fragment offset has been acquired, for each communication session and each IP identifier. Then, when a new communication packet is acquired, the duplicate packet detecting apparatus 3 refers to the first management information and the second management information, and determines whether a communication packet which is identical to the new communication packet in IP identifier and fragment offset has been acquired, in the same communication session as that of the new communication packet. As a result, when it is determined that a communication packet which is identical to the new communication packet in IP identifier and fragment offset has been acquired, the duplicate packet detecting apparatus 3 determines that the new communication packet is a duplicate packet, and discards the duplicate packet.

Accordingly, when a new communication packet is acquired, the duplicate packet detecting apparatus 3 is able to check the duplication of the new communication packet by referring to the first management information and the second management information which correspond to the new communication packet. Thus, when the duplication of a new communication packet is checked, the duplicate packet detecting apparatus 3 does not need to match the new communication packet and a communication packet acquired in the past with each other. Accordingly, the duplicate packet detecting apparatus 3 may reduce the process burden of, for example, the CPU at the time of checking the duplication of a communication packet.

In addition, the duplicate packet detecting apparatus 3 performs the duplication check by referring to the first management information and the second management information, so that the duplicate packet detecting apparatus 3 does not need to store all of communication packets acquired in the past. Thus, the duplicate packet detecting apparatus 3 may reduce the storage area for the communication packets acquired in the past.

Further, the duplicate packet detecting apparatus 3 refers to not only the first management information but also the second management information to perform the duplication check. Thus, even when communication packets flowing through the network NW are divided according to a maximum transmission unit (MTU) of the network NW so that there exist multiple communication packets having the same IP identifier, the duplication of the communication packets may be checked.

<Hardware Configuration of Information Processing System>

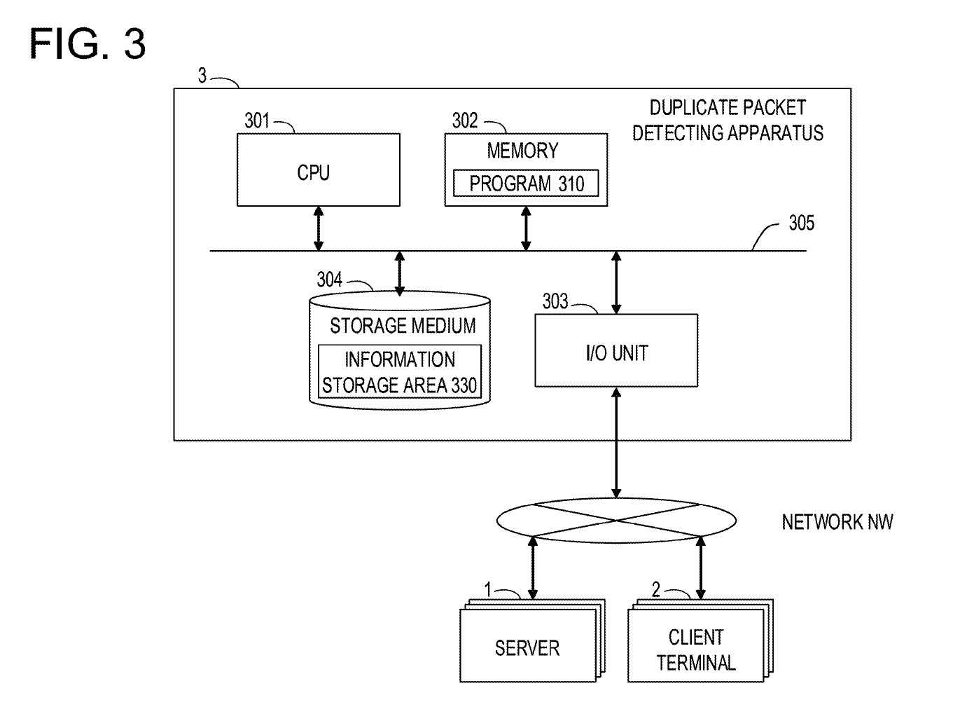

Next, the hardware configuration of the information processing system 10 will be described. FIG. 3 is a diagram illustrating the hardware configuration of the duplicate packet detecting apparatus 3.

As illustrated in FIG. 3, the duplicate packet detecting apparatus 3 is an information processing apparatus including a CPU 301 which is a processor, a memory 302, an external interface (hereinafter, also referred-to as an “I/O unit”) 303, and a storage medium 304. The respective units are connected to each other via a bus 305.

For example, the storage medium 304 stores a program 310 for performing a process of detecting the duplication check of a communication packet (hereinafter, also referred-to as a “packet detecting process”) in a program storage area (not illustrated) of the storage medium 304. The storage medium 304 may be, for example, a hard disk drive (HDD).

Further, the storage medium 304 includes a memory 330 that stores information used for performing the packet detecting process (hereinafter, also referred-to as an “information storage area 330”).

The CPU 301 executes the program 310 loaded from the storage medium 304 into the memory 302 to perform the packet detecting process.

The external interface 303 performs a communication with the server 1 or the client terminal 2 via, for example, the network NW.

<Function of Information Processing System>

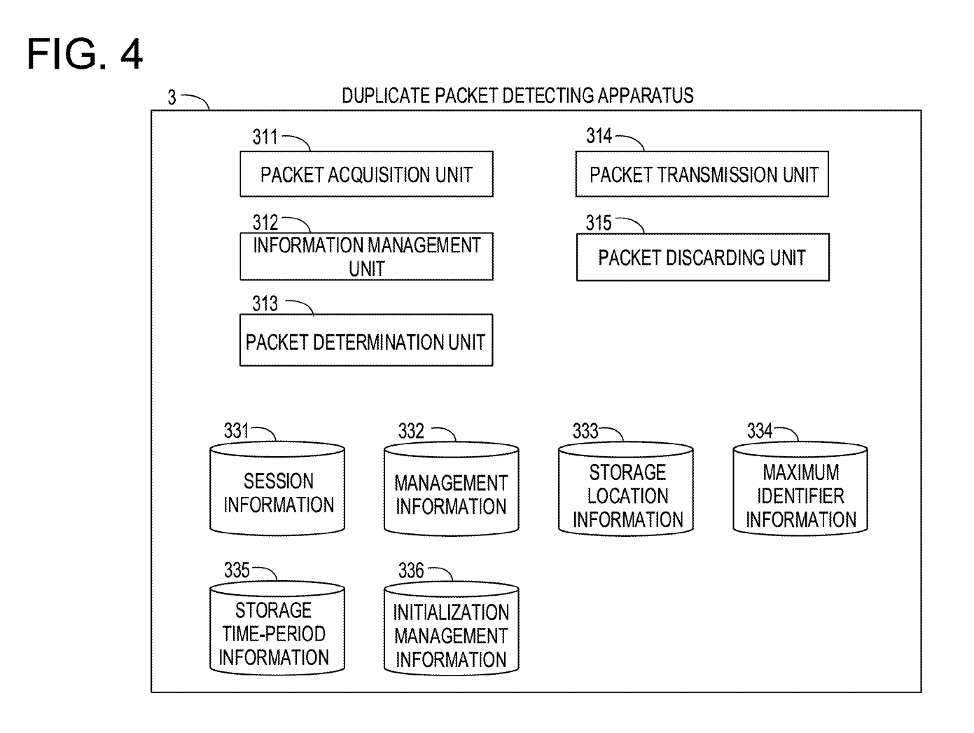

Next, the function of the information processing system 10 will be described. FIG. 4 is a block diagram of the function of the duplicate packet detecting apparatus 3.

As illustrated in FIG. 4, the duplicate packet detecting apparatus 3 implements various functions including a packet acquisition unit 311, an information management unit 312, a packet determination unit 313, a packet transmission unit 314, and a packet discarding unit 315, in the manner that the hardware such as the CPU 301 or the memory 302 organically cooperated with the program 31.

Further, as illustrated in FIG. 4, the duplicate packet detecting apparatus 3 stores session information 331, management information 332, storage location information 333, maximum identifier information 334, storage time-period information 335, and initialization management information 336, in the information storage area 130. In addition, the management information 332 includes first management information 332a and second management information 332b.

For example, the packet acquisition unit 311 acquires a communication packet to be analyzed in the packet analyzing apparatus 5. For example, the packet acquisition unit 311 acquires a communication packet at one or more capturing points provided on the network NW through which the communication packet to be acquired passes.

For example, the information management unit 312 stores session information 331 indicating a communication session in which the communication packet acquired by the packet acquisition unit 311 is transmitted and received, in the information storage area 330. The communication session is established between terminals that transmit and receive a communication packet (e.g., server 1 and client terminal 2), and is a logical connection relationship between terminals that transmit and receive a communication packet. Hereinafter, descriptions will be made assuming that a communication session is established in advance between terminals that transmit and receive a communication packet. A specific example of the session information 331 will be described later.

Further, the information management unit 312 stores the first management information 332a and the second management information 332b which correspond to the communication packet acquired by the packet acquisition unit 311, in the information storage area 330.

The first management information 332a is information corresponding to an IP identifier included in an IP header of a communication packet and is stored for each communication session. For example, the first management information 332a may be a bit string indicating, for each communication session, whether a communication packet corresponding to each IP identifier has been acquired (hereinafter, also referred-to as a “first bit string”). In this case, in each bit included in the first management information 332a, for example, “0” may be set as an initial value. Then, when a new communication packet is acquired, the information management unit 312 may set “1” in a bit corresponding to the IP identifier of the new communication packet.

In addition, the second management information 332b is information corresponding to a fragment offset included in an IP header of a communication packet and is stored for each communication session and each IP identifier. For example, the second management information 332b may be a bit string indicating, for each communication session and each IP identifier, whether a communication packet corresponding to each combination of an IP identifier and a fragment offset has been acquired (hereinafter, also referred-to as a “second bit string”). In this case, in each bit included in the second management information 332b, for example, “0” may be set as an initial value. Then, when a new communication packet is acquired, the information management unit 312 may set “1” in a bit corresponding to the fragment offset of the new communication packet.

In addition, the IP header includes, for example, “transmission source IP” which is information for identifying a transmission source terminal of a communication packet (IP packet) or “transmission destination IP” which is information for identifying a transmission destination terminal, and is assigned to each communication packet. In addition, for example, the IP identifier is information assigned for each communication session in an order of transmission (occurrence) in a transmission source terminal of a communication packet. When a communication packet generated in a specific communication session exceeds a maximum value (e.g., 65535) of the IP identifier, the IP identifier may be assigned returning to the top of the identifiers (e.g., 0) (such identifiers are referred to as “cyclic identifiers”). In addition, the fragment offset is information indicating a division position when communication packets are divided according to the MTU of the network NW.

The information management unit 312 stores storage location information 333 indicating storage locations of the first management information 332a and the second management information 332b, in the information storage area 330. The specific example of the first management information 332a, the second management information 332b, and the storage location information 333 will be described later.

Further, the information management unit 312 stores the maximum value among IP identifiers of communication packets acquired by the packet acquisition unit 311 as maximum identifier information 334 in the information storage area 330. Then, for example, when a value obtained by subtracting the value indicated by the maximum identifier information 334 from an IP identifier of a communication packet acquired by the packet acquisition unit 311 is smaller than a predetermined threshold (e.g., −30000), the information management unit 312 determines that the IP identifier has been cycled. Further, in this case, the information management unit 312 initializes the maximum identifier information 334.

That is, since the IP identifier is assigned in an order of transmitting a communication packet, it may be determined that an IP identifier of a new communication packet becomes larger than the maximum identifier information 334, except for a case where, for example, a network delay is occurring. Thus, for example, when an IP identifier of a new communication packet becomes remarkably smaller than the maximum identifier information 334, the information management unit 312 determines that the IP identifier has been cycled.

In addition, when it is determined that an IP identifier has been cycled, for example, the information management unit 312 may set “0” in bits corresponding to a predetermined number of IP identifiers from a first IP identifier among IP identifiers which are likely to be generated (e.g., the first half of the IP identifiers which are likely to be generated), among the bits included in the first management information 332a. Then, when the IP identifier of the communication packet acquired by the packet acquisition unit 311 reaches an IP identifier corresponding to a bit where “1” is likely set (e.g., an identifier in the middle of the IP identifiers which are likely to be generated) in the first management information 332a, the information management unit 312 may set “0” in bits corresponding to a predetermined number of IP identifiers subsequent to the IP identifier corresponding to the bit where “0” was previously set (e.g., the second half of the IP identifiers which are likely to be generated), among the bits included in the first management information 332a.

That is, when an IP identifier has been cycled, a communication packet having the same IP identifier is generated multiple times. Thus, for example, before a communication packet including an IP identifier assigned in the past is acquired, the information management unit 312 initializes the bits included in the first management information 332a.

In addition, the information management unit 312 may refer to the storage time-period information 335 in which a storage time period of the first management information 332a is stored and the initialization management information 336 for managing a time when “1” is set in each bit included in the first management information 332a, and set “0” in a bit of which storage time period has elapsed since the setting of “1,” among the bits included in the first management information 332a.

Specifically, the information management unit 312 may store an IP identifier corresponding to a bit where “1” is set, for each of consecutive counted time periods. Then, for example, the information management unit 312 may set “0” in a bit corresponding to an IP identifier set in a counted time period after the elapse of the storage time period.

Thus, when the packet acquisition unit 311 acquires a communication packet, the packet determination unit 313 identifies a communication session in which the acquired communication packet is transmitted and received, based on information identifying a communication session included in the header of the acquired communication packet. Then, the packet determination unit 313 refers to the first management information 332a stored in the information storage area 330, and determines whether “1” is set in a bit corresponding to the IP identifier of the acquired communication packet in the bit string corresponding to the identified communication session. As a result, when it is determined that “1” is set, the packet determination unit 313 refers to the second management information 332b stored in the information storage area 330, and determines whether “1” is set in a bit corresponding to a fragment offset of the acquired communication packet in the bit string corresponding to a combination of the identified communication session and the IP identifier of the acquired communication packet.

When it is determined that “1” is not set in the bit corresponding to the IP identifier of the communication packet acquired by the packet acquisition unit 311, or “1” is not set in the bit corresponding to the fragment offset of the communication packet acquired by the packet acquisition unit 311, the packet transmission unit 314 outputs the communication packet acquired by the packet acquisition unit 311. Specifically, in this case, the packet transmission unit 314 transmits the communication packet acquired by the packet acquisition unit 311 to the packet analyzing apparatus 5.

In addition, for example, the packet transmission unit 314 may store the communication packet acquired by the packet acquisition unit 311 in the duplicate packet detecting apparatus 3 (e.g., the information storage area 330) before transmitting the communication packet acquired by the packet acquisition unit 311 to the packet analyzing apparatus 5.

Then, when it is determined that “1” is not set in the bit corresponding to the IP identifier of the communication packet acquired by the packet acquisition unit 311, or “1” is not set in the bit corresponding to the fragment offset of the communication packet acquired by the packet acquisition unit 311, the information management unit 312 sets “1” in the bit corresponding to the IP identifier of the communication packet acquired by the packet acquisition unit 311. Further, in this case, the information management unit 312 sets “1” in the bit corresponding to the fragment offset of the communication packet acquired by the packet acquisition unit 311.

When it is determined that “1” is set in the bit corresponding to the fragment offset of the communication packet acquired by the packet acquisition unit 311, the packet discarding unit 315 determines that the communication packet acquired by the packet acquisition unit 311 is a duplicate packet, and discards the duplicate packet.

<Outline of First Embodiment>

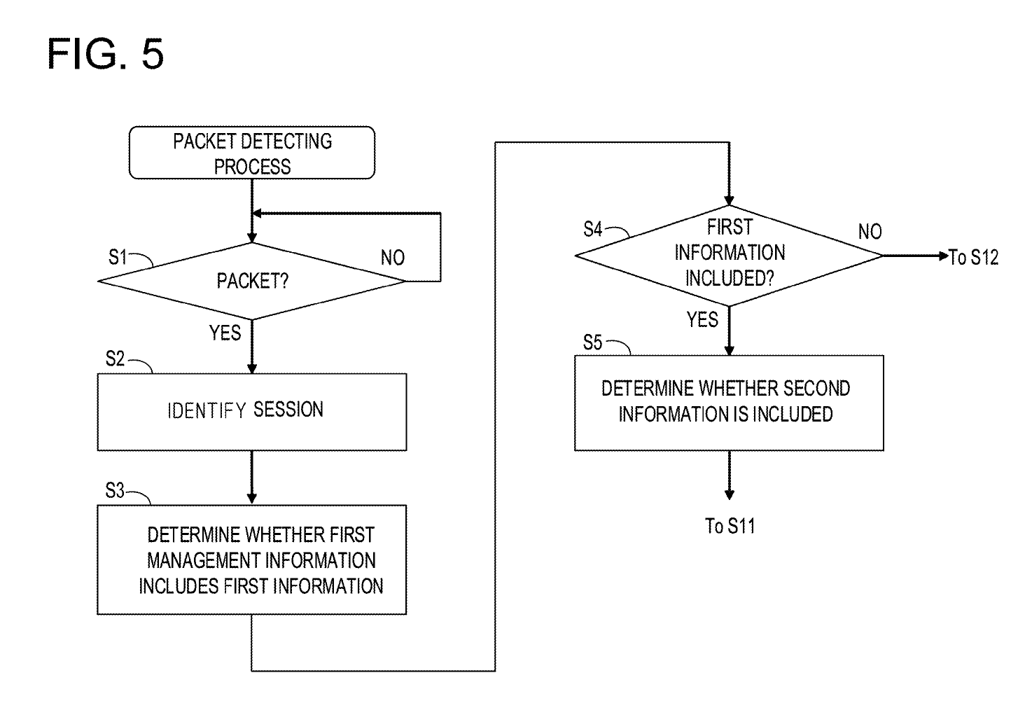

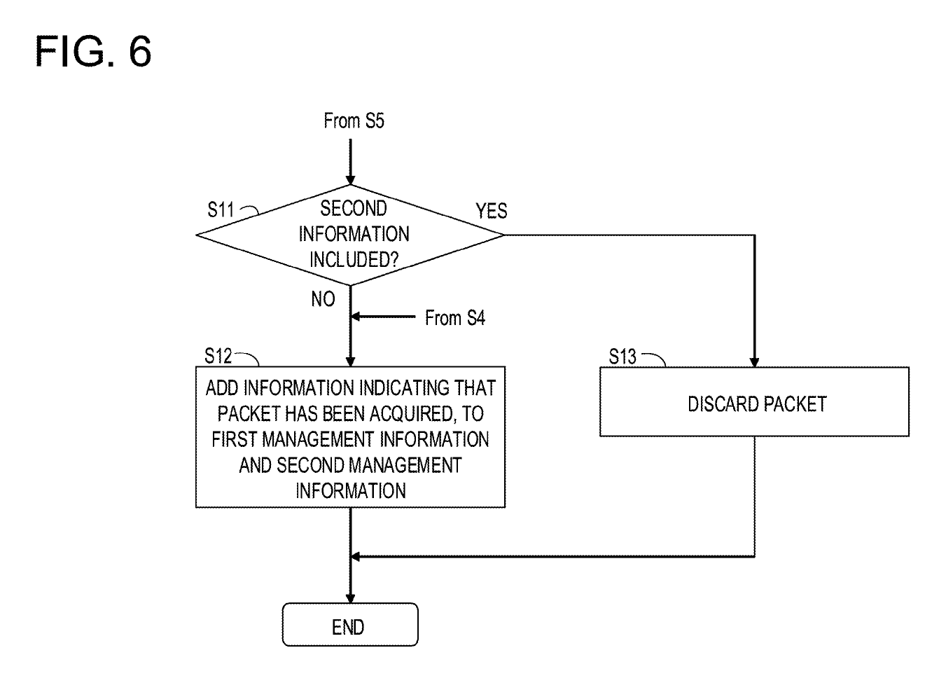

Next, an outline of a first embodiment will be described. FIGS. 5 and 6 are flowcharts for explaining the outline of the packet detecting process according to the first embodiment.

As illustrated in FIG. 5, the duplicate packet detecting apparatus 3 waits until a communication packet is acquired from the capturing points (“NO” in S1).

Then, when a communication packet is acquired (“YES” in S1), the duplicate packet detecting apparatus 3 identifies a communication session in which the acquired communication packet is transmitted and received, based on the information identifying a communication session included in the header (IP header) of the acquired communication packet (S2).

Subsequently, the duplicate packet detecting apparatus 3 refers to the memory 330 that stores the first management information 332a indicating, for each communication session, whether a communication packet corresponding to each IP identifier has been acquired, and determines whether the first management information 332a corresponding to the communication session identified by the process of S2 includes the first information indicating that the communication packet corresponding to the IP identifier of the communication packet acquired in the process of S1 has been acquired (S3).

As a result, when it is determined that the first management information 332a includes the first information (“YES” in S4), the duplicate packet detecting apparatus 3 determines whether the second management information 332b corresponding to a combination of the communication session identified in the process of S2 and the IP identifier of the communication packet acquired in the process of S1 includes the second information indicating that the communication packet corresponding to the fragment offset of the communication packet acquired in the process of S1 has been acquired (S5).

Then, as illustrated in FIG. 6, when it is determined that the second management information 332b does not include the second information (“NO” in S11) and when it is determined in the process of S4 that the first management information 332a does not include the first information (“NO” in S4), the duplicate packet detecting apparatus 3 adds the information indicating that the communication packet acquired in the process of S1 has been acquired, to the first management information 332a and the second management information 332b (S12).

Meanwhile, when it is determined that the second management information 332b includes the second information (“YES” in S11), the duplicate packet detecting apparatus 3 discards the communication packet acquired in the process of S1 (S13).

Accordingly, when a new communication packet is acquired, the duplicate packet detecting apparatus 3 is able to check the duplication of the new communication packet by referring to the first management information 332a and the second management information 332b which correspond to the new communication packet. Thus, when the duplication of the new communication packet is checked, the duplicate packet detecting apparatus 3 does not need to match the new communication packet and a communication packet acquired in the past with each other. Accordingly, the duplicate packet detecting apparatus 3 may reduce the process burden of, for example, the CPU at the time of checking the duplication of a communication packet.

In addition, the duplicate packet detecting apparatus 3 performs the duplication check by referring to the first management information 332a and the second management information 332b, so that the duplicate packet detecting apparatus 3 does not need to save all of communication packets acquired in the past. Thus, the duplicate packet detecting apparatus 3 may reduce the storage area required for communication packets acquired in the past.

Further, the duplicate packet detecting apparatus 3 refers to not only the first management information 332a but also the second management information 332b to perform the duplication check. Thus, even when communication packets flowing through the network NW are divided according to the MTU of the network NW so that there exist multiple communication packets having the same IP identifier, the duplication of a communication packet may be checked.

<Details of First Embodiment>

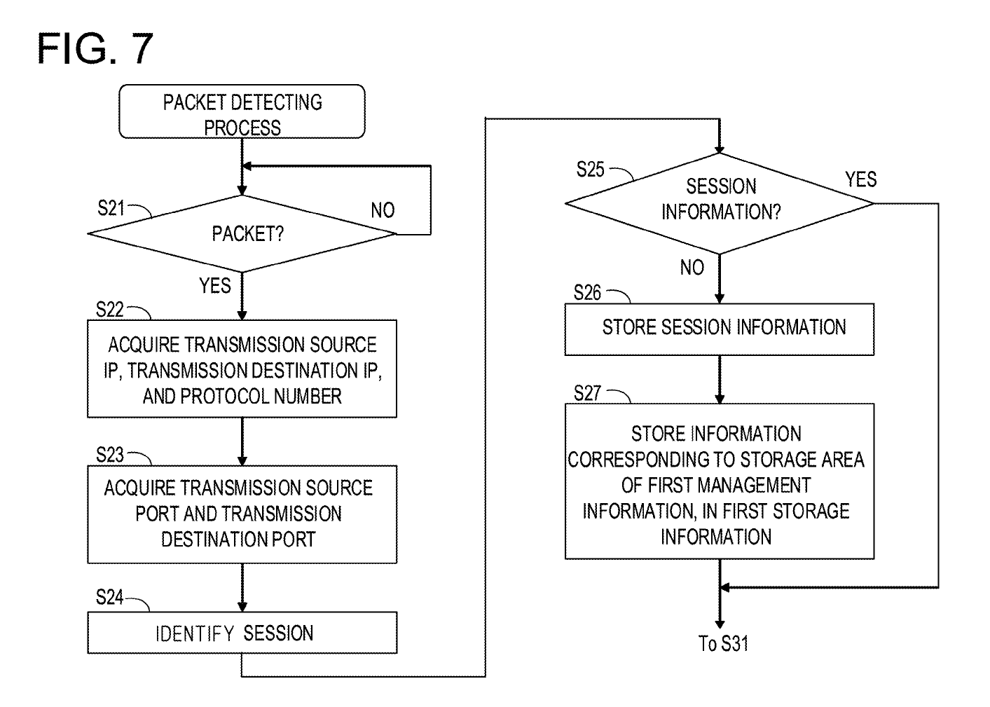

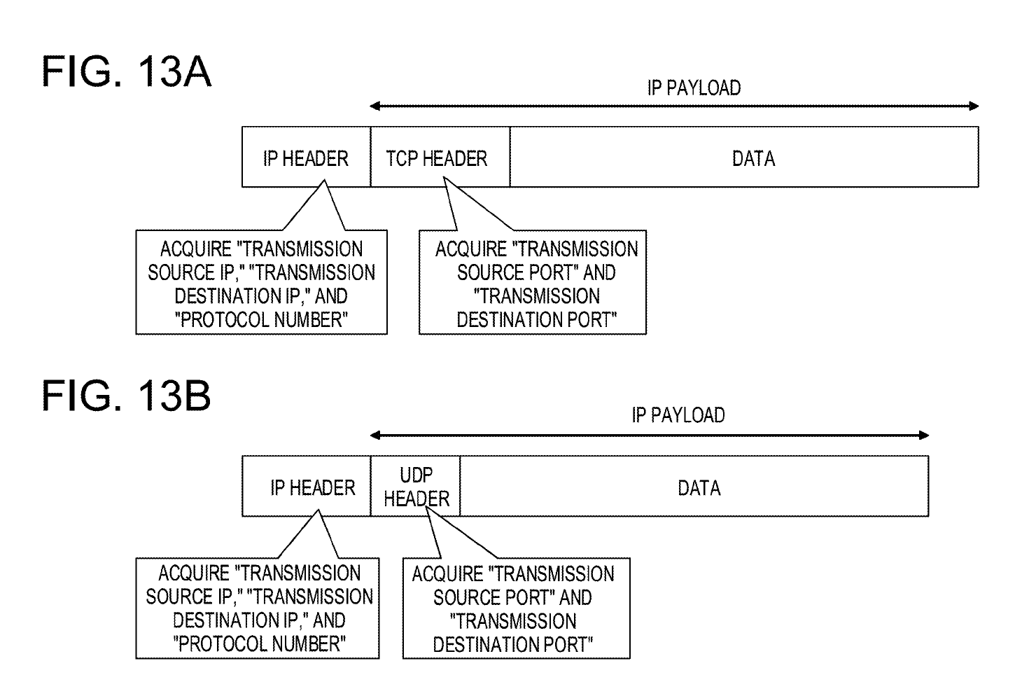

Next, details of the first embodiment will be described. FIGS. 7 to 12 are flowcharts for explaining details of the packet detecting process according to the first embodiment. In addition, FIGS. 13A and 13B to FIGS. 22A and 22B are flowcharts for explaining specific examples of various pieces of information in the packet detecting process according to the first embodiment. Referring to FIGS. 13A and 13B to FIGS. 22A and 22B, the details of the packet detecting process illustrated in FIGS. 7 to 12 will be described.

As illustrated in FIG. 7, the duplicate packet detecting apparatus 3 waits until a communication packet is acquired at the capturing points (“NO” in S21).

Then, when a communication packet is acquired (“YES” in S21), the packet acquisition unit 311 acquires information for identifying a communication session including the acquired communication packet (S22 and S23). Specifically, in this case, the packet acquisition unit 311 acquires a transmission source IP, a transmission destination IP, and a protocol number from the IP header of the acquired communication packet (S22). Further, in this case, the packet acquisition unit 311 acquires a transmission source port and a transmission destination port from a transmission control protocol (TCP) header of the acquired packet (S23). The specific example of the processes of S22 and S23 is described below.

<Specific Example of Processes of S22 and 23>

FIGS. 13A and 13B are diagrams illustrating a configuration of a communication packet (IP packet). An IP packet includes an IP header that includes information such as a “transmission source IP” or a “transmission destination IP,” and an IP payload. As illustrated in FIG. 13A, in the present embodiment, a communication packet includes an IP packet having a TCP header as illustrated in FIG. 13A and an IP packet having a user datagram protocol (UDP) header. Specifically, the IP payload of the IP packet illustrated in FIG. 13A includes the TCP header that includes information such as a “transmission source port” or a “transmission destination port,” and a TCP payload (data). In addition, the IP payload of the IP packet illustrated in FIG. 13B includes a UDP header that includes information such as a “transmission source port” or a “transmission destination port,” and a UDP payload (data).

Then, as illustrated in FIGS. 13A and 13B, the packet acquisition unit 311 refers to the IP header, and acquires a “transmission source IP,” a “transmission destination IP,” and a “protocol number (protocol information)” of the acquired communication packet (S22). Further, as illustrated in FIGS. 13A and 13B, the packet acquisition unit 311 refers to the TCP header or the UDP header, and acquires a “transmission source port” and a “transmission destination port” of the acquired communication packet (S23).

That is, the packet acquisition unit 311 acquires information necessary for identifying a communication session in which the acquired communication packet is transmitted and received, from the IP header and the TCP header (UDP header) of the acquired communication packet.

As a result, the information management unit 312 is able to uniquely identify the communication session in which the communication packet acquired by the packet acquisition unit 311 is communicated.

Referring back to FIG. 7, the information management unit 312 of the duplicate packet detecting apparatus 3 identifies a communication session including the communication packet acquired in the process of S21, based on the information acquired in the processes of S22 and S23 (S24).

Subsequently, for example, the information management unit 312 confirms whether the session information 331 on the communication session identified in the process of S24 is stored in the information storage area 330 (S25). Then, when it is determined that the session information 331 is not stored (“NO” in S25), for example, the information management unit 312 stores the session information 331 indicating the communication session including the communication packet acquired in the process of S21 in the information storage area 330, based on the information acquired in the processes of S22 and S23 (S26). Hereinafter, a specific example of the session information 331 will be described.

<Specific Example of Session Information>

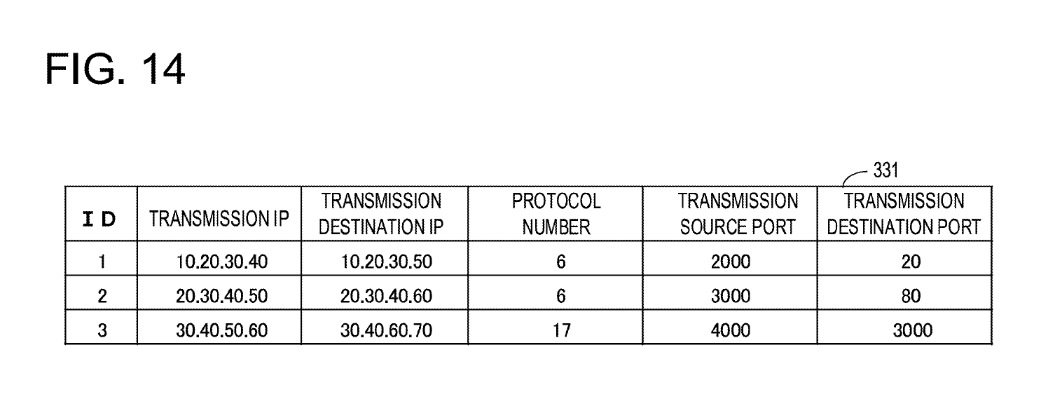

FIG. 14 is a view for explaining a specific example of the session information 331.

The session information 331 illustrated in FIG. 14 includes, as items, “ID” assigned for each communication session, a “transmission source IP” which is an IP address of a transmission source terminal, a “transmission destination IP” which is an IP address of a transmission destination terminal, and a “protocol number” indicating a protocol number of the communication session. Further, the session information 331 illustrated in FIG. 14 includes, as items, a “transmission source port” which is a port number of the transmission source terminal, and a “transmission destination port” which is a port number of the transmission destination terminal.

Specifically, for the information with the “ID” of “1” in the session information 331 illustrated in FIG. 14, “10.20.30.40” is set as the “transmission source IP,” “10.20.30.50” is set as the “transmission destination IP,” and “6” is set as the “protocol number.” In addition, for the information with the “ID” of “1” in the session information 331 illustrated in FIG. 14, “2000” is set as the “transmission source port,” and “20” is set as the “transmission destination port.” The descriptions of the other information included in FIG. 14 will be omitted.

Referring back to FIG. 7, the information management unit 312 secures a storage area for storing the first management information 332a (bit strings) corresponding to the communication session including the communication packet acquired in the process of S21, and stores the information corresponding to the secured storage area in the first storage location information 333a (S27). The first storage location information 333a is information in which the storage location of the first management information 332a and the storage location of the second storage location information 333b are associated with each other, in the storage location information 333. In addition, the second storage location information 333b is information indicating the storage location of the second management information 332b for each communication session, in the storage location information 333. The specific examples of the first storage location information 333a and the second storage location information 333b will be described later.

Meanwhile, when it is determined in the process of S25 that the session information 331 is stored (“YES” in S25), the information management unit 312 does not perform the processes of S26 and S27.

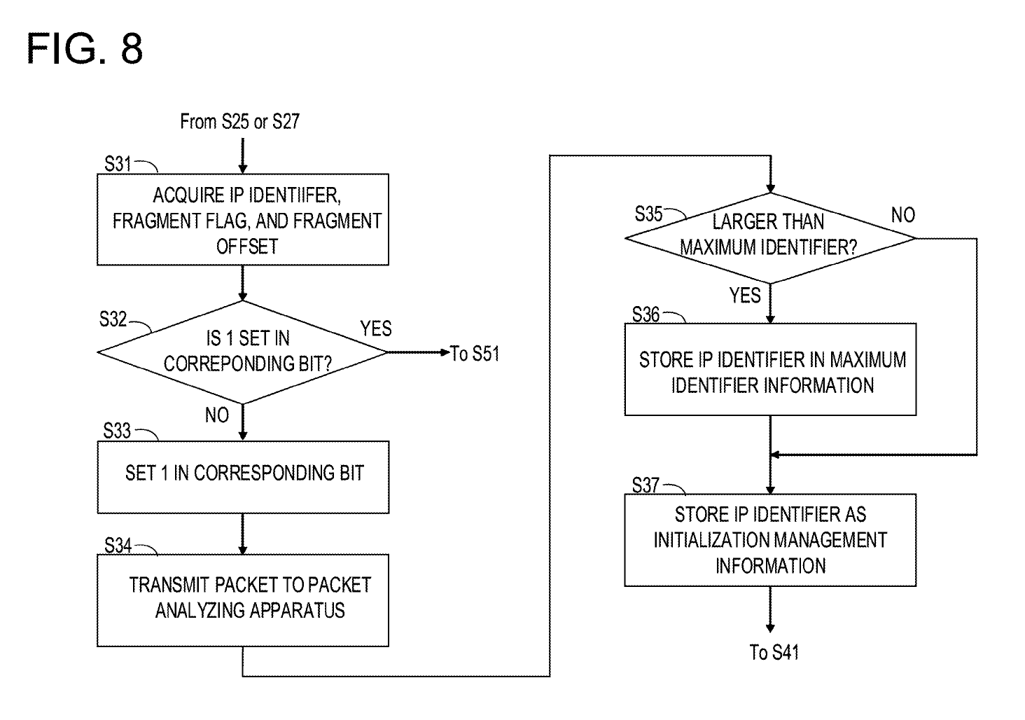

Subsequently, as illustrated in FIG. 8, the information management unit 312 acquires each of an IP identifier, a fragment flag, and a fragment offset included in the IP header of the communication packet acquired in the process of S21 (S31).

Subsequently, the packet determination unit 313 of the duplicate packet detecting apparatus 3 determines whether “1” is set in the bit corresponding to the IP identifier acquired in the process of S31, among the bits included in the first management information 332a (bit strings) stored in the information storage area 330 (S32). That is, the packet determination unit 313 determines whether another communication packet of which IP header has the IP identifier acquired in the process of S31 has been acquired. Hereinafter, a specific example of the first management information 332a will be described.

<Specific Example of First Management Information>

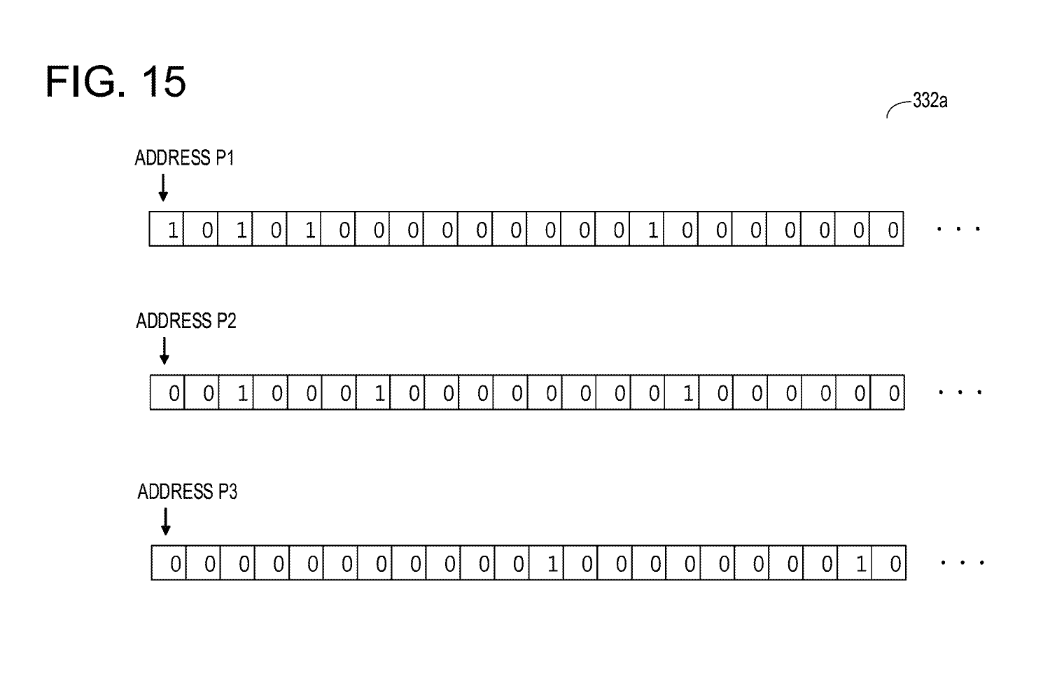

FIG. 15 is a view for explaining a specific example of the first management information 332a. FIG. 15 is a view for explaining a bit string stored in an area of which head address is an address P1, a bit string stored in an area of which head address is an address P2, and a bit string stored in an area of which head address is an address P3, among the bit strings included in the first management information 332a. Hereinafter, descriptions will be made assuming that the bit strings of which head addresses are the addresses P1, P2, and P3 correspond to the pieces of information with the “IDs” of “1” to “3,” respectively, in the session information 331 described in FIG. 14. Further, descriptions will be made assuming that each bit string included in the first management information 332a is constituted by bits each corresponding to an IP identifier which is likely to be included in an IP header of a communication packet (e.g., 0 to 65535).

Specifically, “1” is stored in each of the first, third, and fifth bits from the head in the bit string of which head address is the address P1, among the bit strings included in the first management information 332a illustrated in FIG. 15, to indicate that a communication packet including a corresponding IP identifier has been acquired. Meanwhile, “0” is stored in each bit other than the first, third, and fifth bits from the head in the bit string of which head address is the address P1, among the bit strings included in the first management information 332a illustrated in FIG. 15, to indicate that a communication packet including a corresponding IP identifier has not been acquired. The descriptions of the other information included in FIG. 15 will be omitted.

That is, the duplicate packet detecting apparatus 3 manages the first management information 332a according to a bit string corresponding to each IP identifier, so that the duplicate packet detection apparatus 3 is able to readily determine whether a communication packet having each IP identifier has been acquired. As a result, the duplicate packet detecting apparatus 3 may suppress the increase in the process burden of, for example, the CPU accompanied by the duplication check of a communication packet.

In addition, in the process of S31, for example, the information management unit 312 may refer to the maximum identifier information 334 stored in the information storage area 330, and determine whether a value obtaining by subtracting the value indicated by the maximum identifier information 334 from the IP identifier acquired in the process of S31 is smaller than a predetermined threshold (e.g., −30000), so as to determine whether the IP identifier has been cycled. When it is determined that the IP identifier has been cycled, for example, the information management unit 312 may set “0” in bits corresponding to a predetermined number of IP identifiers from a first IP identifier which is likely to be generated (e.g., the first half of the IP identifiers which are likely to be generated), among the bits included in the first management information 332a stored in the information storage area 330.

In addition, when it is determined that the IP identifier acquired in the process of S31 reaches the IP identifier where “1” is likely set (e.g., the IP identifier in the middle of the IP identifiers which are likely to be generated) in the first management information 332a, for example, the information management unit 312 may set “0” in bits corresponding to a predetermined number of IP identifiers subsequent to the IP identifier corresponding to the first management information 332a in which “0” was previously set (e.g., the second half of the IP identifiers which are likely to be generated), among the bits included in the first management information 332a stored in the information storage area 330.

Referring back to FIG. 8, when it is determined that “0” is stored in the bit corresponding to the IP identifier acquired in the process of S31 (“NO” in S32), the information management unit 312 stores “1” in the bit corresponding to the IP identifier acquired in the process of S31, among the bits included in the first management information 33a stored in the information storage area 130 (S33).

Then, for example, the packet transmission unit 314 of the duplicate packet detecting apparatus 3 transmits the communication packet acquired by the packet acquisition unit 311 to the packet analyzing apparatus 5 (S34).

That is, when “1” is not stored in the bit corresponding to the IP identifier acquired in the process of S31, the packet determination unit 313 determines that the communication packet corresponding to the IP identifier is not a duplicate packet. Thus, in this case, the packet transmission unit 314 transmits the communication packet acquired in the process of S21 to the packet analyzing apparatus 5.

In addition, when it is determined that the IP identifier acquired in the process of S31 is larger than the value corresponding to the maximum identifier information 334 (“YES” in S35), the information management unit 312 stores the IP identifier acquired in the process of S31 as the maximum identifier information 334 in the information storage area 330 (S36).

As a result, the information management unit 312 is able to detect that the IP identifier included in the IP header of the communication packet has been cycled.

In addition, when it is determined that the IP identifier acquired in the process of S31 is equal to or smaller than the value corresponding to the maximum identifier information 334 stored in the information storage area 330 (“NO” in S35), the information management unit 312 does not perform the process of S36.

Then, the information management unit 312 stores the IP identifier acquired in the process of S31 as the initialization management information 336 in the information storage area 330 (S37). A specific example of the initialization management information 336 will be described later.

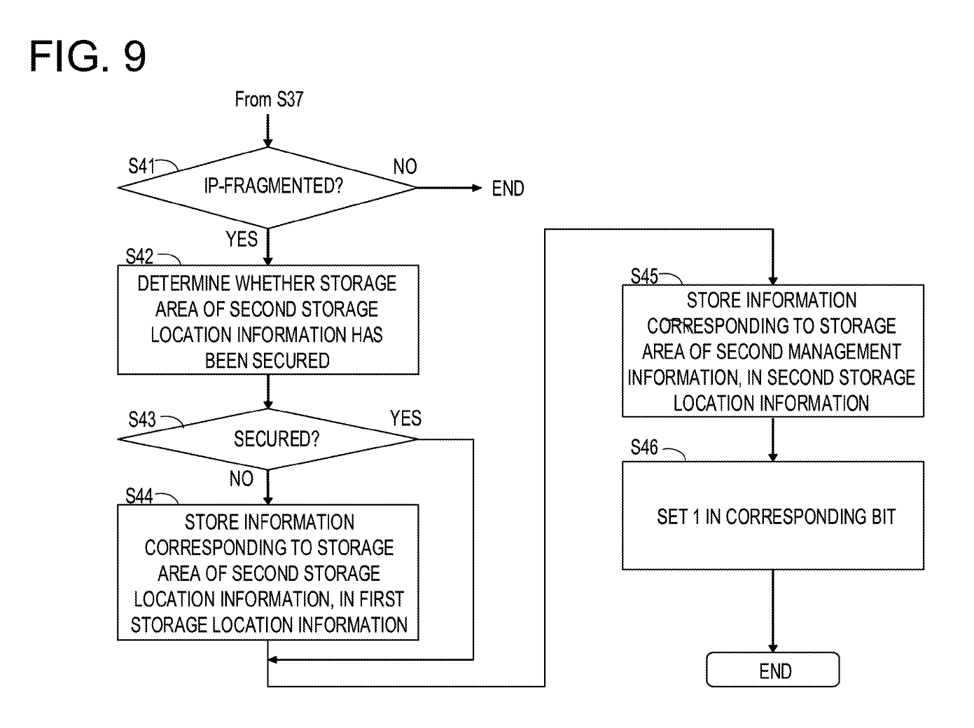

Subsequently, as illustrated in FIG. 9, when it is determined that the communication packet acquired in the process of S21 is an IP-fragmented communication packet (“YES” in S41), the information management unit 312 determines whether a storage area of the second storage location information 333b corresponding to the communication session identified in the process of S24 is secured (S42). A specific example of the second storage location information 333b will be described later.

As a result, when it is determined that the storage area of the second memory location information 333b is not secured (“NO” in S43), the information management unit 312 secures the storage area of the second storage location information 333b corresponding to the communication session identified in the process of S24, and stores the information corresponding to the secured area in the first storage location information 333a (S44). A specific example of the first storage location information 333a will be described later.

In addition, when it is determined that the storage area of the second storage location information 333b is secured (“YES” in S43), the information management unit 312 does not perform the process of S44.

Then, the information management unit 312 secures a storage area of the second management information 332b corresponding to the IP identifier acquired in the process of S31, and stores the information corresponding to the secured area in the second storage location information 333b (S45).

That is, the communication packet acquired in the process of S21 may include an IP-unfragmented communication packet. Thus, the information management unit 312 secures the storage area of the second storage location information 333b corresponding to the communication session identified by the process of S24 and the storage area of the second management information 332b corresponding to the IP identifier of the communication packet acquired in the process of S21, only when it is determined that the communication packet acquired in the process of S21 is an IP-fragmented communication packet.

As a result, the packet detecting apparatus 3 may suppress the increase of the storage areas of the second storage location information 333b and the second management information 332b.

Then, the information management unit 312 stores “1” in the bit corresponding to the fragment offset acquired in the process of S31, among the bits included in the second management information 332b (bit strings) of which storage area has been secured in the process of S45 (S46). Then, the duplicate packet detecting apparatus 3 ends the packet detecting process.

In addition, when it is determined that the communication packet acquired in S21 is not an IP fragmented packet (“YES” in S41), the information management unit 312 does not perform the processes of S42 to S46.

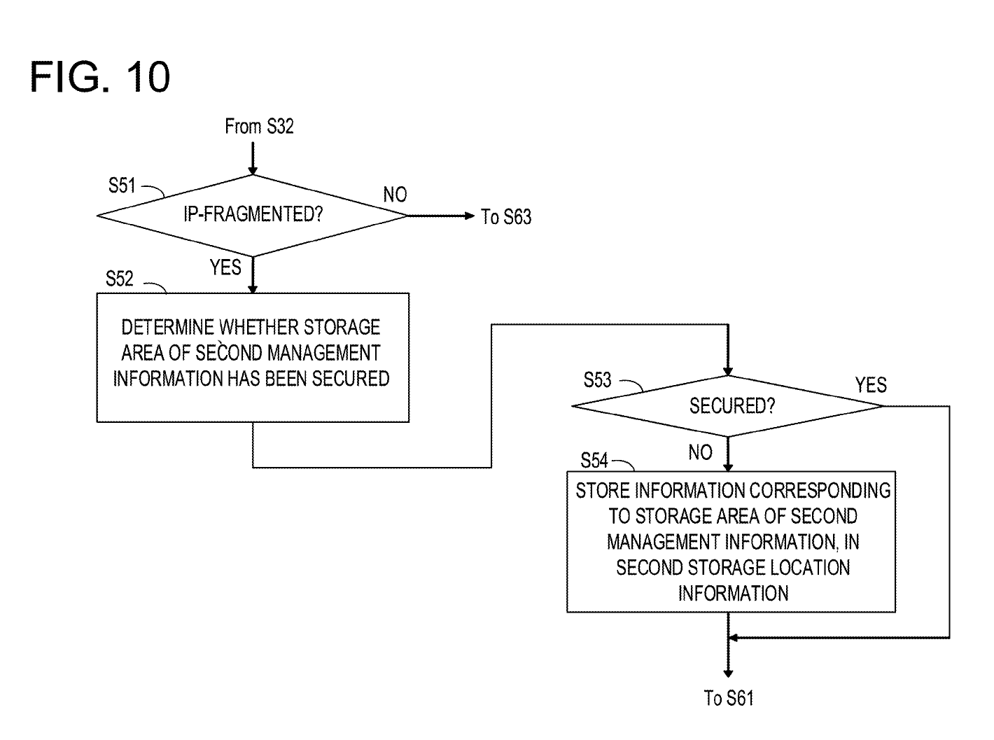

Meanwhile, when “1” is stored in the bit corresponding to the IP identifier acquired in the process of S31 (“YES” in S32), the information management unit 312 determines whether the communication packet acquired in the process of S21 is an IP-fragmented communication packet as illustrated in FIG. 10 (S51).

Specifically, for example, the information management unit 312 refers to the fragment flag acquired in the process of S31, and determines whether “1” is set in the second bit of the fragment flag, that is, whether information indicating that the communication packet acquired in the process of S21 is an IP-fragmented packet is set.

As a result, when it is determined that the communication packet acquired in the process of S21 is an IP-fragmented packet (“YES” in S51), the information management unit 312 determines whether a storage area for storing the second management information 332b (bit strings) corresponding to the fragment offset acquired in the process of S31 is secured (S52).

Then, when it is determined that the storage area for storing the second management information 332b corresponding to the IP identifier acquired in the process of S31 is not secured (“NO” in S53), the information management unit 312 secures the storage area of the second management information 332b (bit strings) corresponding to the IP identifier acquired in the process of S31, and stores the information corresponding to the secured area in the second storage location information 333b (S54).

Meanwhile, when it is determined that the storage area for storing the second management information 332b corresponding to the IP identifier acquired in the process of S31 is secured (“YES” in S53), the information management unit 312 does not perform the process of S54. Hereinafter, a specific example of the storage location information 333 will be described.

<Specific Example of Storage Location Information>

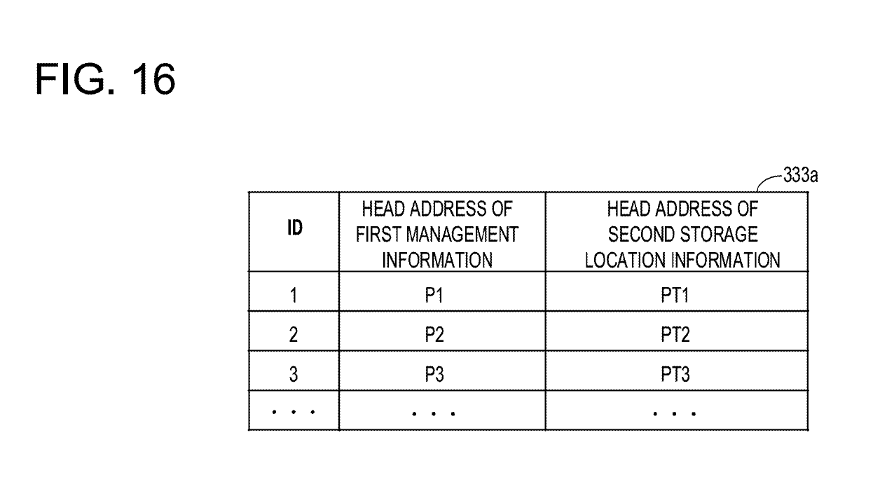

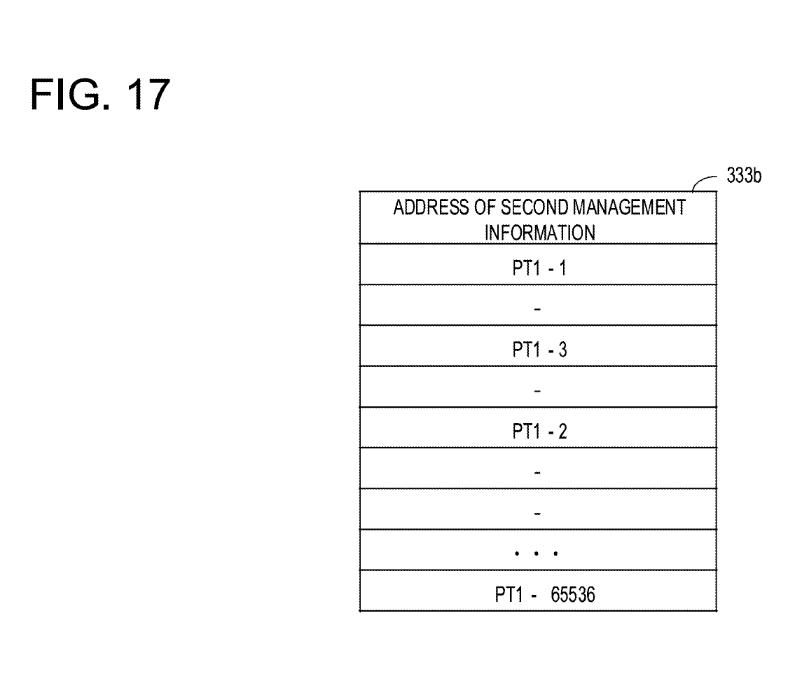

FIGS. 16 and 17 are views for explaining a specific example of the storage location information 333. Specifically, FIG. 16 is a view for explaining a specific example of the first storage location information 333a. In addition, FIG. 17 is a view for explaining a specific example of the second storage location information 333b.

First, a specific example of the first storage location information 332a will be described.

The first storage location information 333a illustrated in FIG. 16 includes, as items, an “ID” assigned for each communication session and the “head address of first management information” which is the information set in the process of S27 and in which the head address of the storage location of the first management information 332a is set. Further, the first storage location information 333a illustrated in FIG. 16 includes, as an item, the “head address of second storage location information” which is the information set in the process of S44 and in which the head address of the storage area where the second storage location information 333b is stored is set.

Specifically, for the information with the “ID” of “1” in the first storage location information 333a illustrated in FIG. 16, “P1” is set as the “head address of first management information,” and “PT1” is set as the “head address of second storage location information.” In addition, for the information with the “ID” of “2” in the first storage location information 333a illustrated in FIG. 16, “P2” is set as the “head address of first management information,” and “PT2” is set as the “head address of second storage location information.” The descriptions of the other information included in FIG. 16 will be omitted.

Subsequently, a specific example of the second storage location information 333b will be described. Specifically, FIG. 17 is a view for explaining a specific example of the second storage location information 333b corresponding to the communication session with the “ID” of “1” in the second storage location information 333b. That is, the head address of the second storage location information 333b illustrated in FIG. 17 is “PT1” which is the information set as the “head address of second storage location information” for the information with the “ID” of “1” in the first storage location information 333a illustrated in FIG. 16.

The second storage location information 333b illustrated in FIG. 17 includes, as an item, the “address of second management information” which is the information set in the process of S45 or S54, and in which the head address of the storage location of the second management information 332b is set. In each row of the “address of second management information,” the head address of the second management information 332b (bit string) corresponding to each IP identifier included in a communication packet is set. Thus, the second storage location information 333b illustrated in FIG. 17 includes rows corresponding to 0 to 65535, respectively, which are likely to be set as IP identifiers of communication packets.

Specifically, in the second storage location information 333b illustrated in FIG. 17, “PT1-1” is set in the first row from the top, “-” is set in the second row from the top, and “PT1-3” is set in the third row from the top. That is, in the second storage location information 333b illustrated in FIG. 17, the information is set which indicates that the head address of the second management information 332b corresponding to the communication packet with the IP identifier of “0” is “PT1-1.” In addition, in the second storage location information 333b illustrated in FIG. 17, the information is set which indicates that the second management information 332b corresponding to the communication packet with the IP identifier of “1” does not yet exist. In addition, in the second storage location information 333b illustrated in FIG. 17, the information is set which indicates that the head address of the second management information 332b corresponding to the communication packet with the IP identifier of “2” is “PT1-3.” The descriptions of the other information illustrated in FIG. 17 will be omitted.

That is, the duplicate packet detecting apparatus 3 manages the second storage location information 333b as information having the rows corresponding to the respective IP identifiers, so that the duplicate packet detecting apparatus 3 is able to readily identify the head address of the second management information 332b corresponding to each IP identifier. As a result, the duplicate packet detecting apparatus 3 may further suppress the increase in the process burden of, for example, the CPU accompanied by the duplication check of a communication packet.

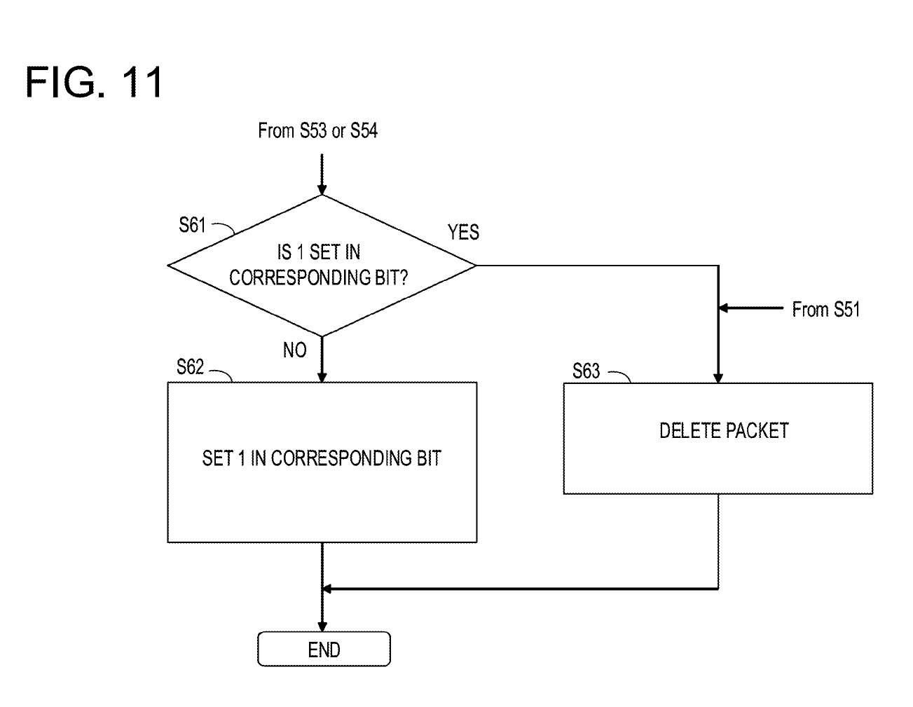

Referring back to FIG. 11, for example, the packet determination unit 313 determines whether “1” is set in the bit corresponding to the fragment offset acquired in the process of S31, among the bits included in the second management information 332b (bit strings) stored in the information storage area 330.

That is, the packet determination unit 313 determines whether the communication packet having the fragment offset acquired in the process of S31 has been acquired. Hereinafter, a specific example of the second management information 332b will be described.

<Specific Example of Second Management Information>

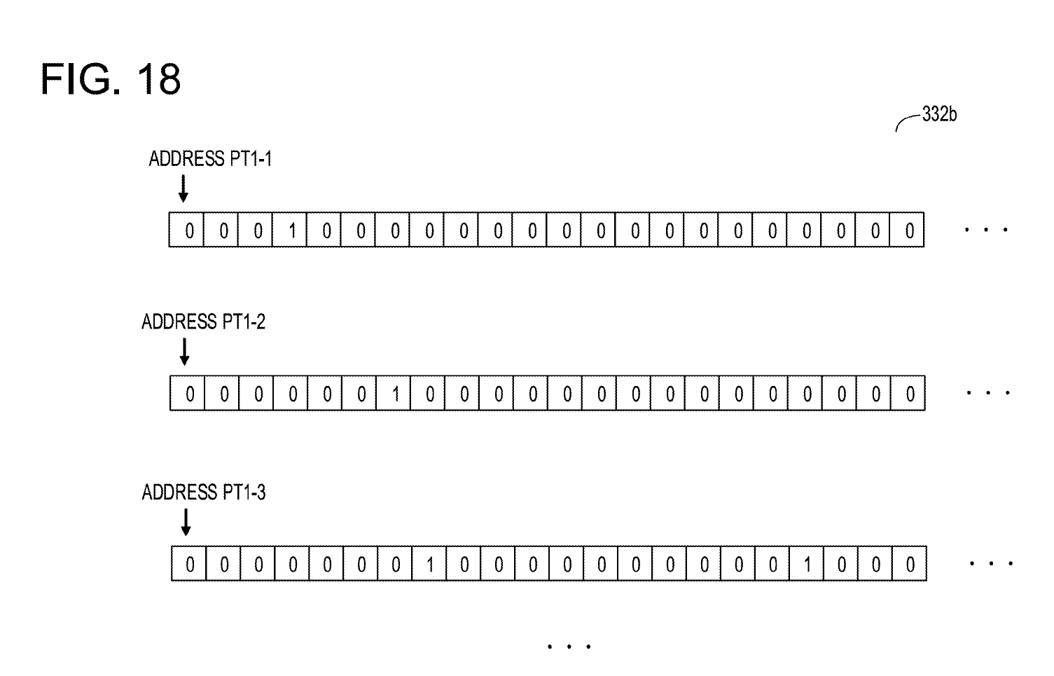

FIG. 18 is a view for explaining a specific example of the second management information 332b. Specifically, FIG. 18 is a view for explaining a bit string stored in an area having the address PT1-1 as a head address, a bit string stored in an area having the address PT1-2 as a head address, and a bit string stored in an area having the address PT1-3 as a head address, among the bit strings included in the second management information 332b.

In addition, the maximum data length of the data portion of the communication packet (IP packet) is 64 (kilobytes). Meanwhile, the minimum data length of the data portion of the MTU is 512 (bytes). Thus, the data length of a communication packet other than the last communication packet, among the communication packets divided according to the MTU, never becomes smaller than 512 (bytes). In addition, when 64 (kilobyte) which is the maximum data length of the data portion of a communication packet is divided by 512 (bytes) which is the minimum data length of the data portion of the MTU, a value of 128 is obtained. Thus, each bit string included in the second management information 332b may be a bit string formed with, for example, 128 (bits).

Specifically, “1” is stored in the fourth bit from the head in the bit string having the address PT1-1 as a head address, among the bit strings included in the second management information 332b illustrated in FIG. 18, to indicate that a communication packet including a corresponding fragment offset has been acquired. Meanwhile, “0” is stored in the bits other than the fourth bit from the head in the bit string having the address PT1-1 as a head address, among the bit strings included in the second management information 332b illustrated in FIG. 18, to indicate that a communication packet including a corresponding fragment offset has not been acquired. The descriptions of the other information included in FIG. 18 will be omitted.

That is, the duplicate packet detecting apparatus 3 manages the second management information 332b according to the bit strings corresponding to respective fragment offsets, so that the duplicate packet detecting apparatus 3 is able to readily determine whether a communication packet having each fragment offset has been acquired. As a result, the duplicate packet detecting apparatus 3 may further suppress the increase in the process burden of, for example, the CPU accompanied by the duplication check of a communication packet.

Referring back to FIG. 11, when it is determined that “0” is stored in the bit corresponding to the fragment offset acquired in the process of S31, among the bits included in the second management information 332b (bit strings) stored in the information storage area 330 (“NO” in S61), the information management unit 312 stores “1” in the bit corresponding to the fragment offset acquired in the process of S31 (S62).

Meanwhile, when it is determined that “1” is stored in the bit corresponding to the fragment offset acquired in the process of S31 (“YES” in S61), the packet discarding unit 315 of the duplicate packet detecting apparatus 3 deletes the communication packet acquired in the process of S21 (S63).

In addition, when it is determined that the communication packet acquired in the process of S21 is not an IP-fragmented packet (“NO” in S51), the packet discarding unit 315 also deletes the communication packet acquired in the process of S21 (S63).

Then, after the process of S62 or S63, the duplicate packet detecting apparatus 3 ends the packet detecting process.

<Management Information Initiating Process>

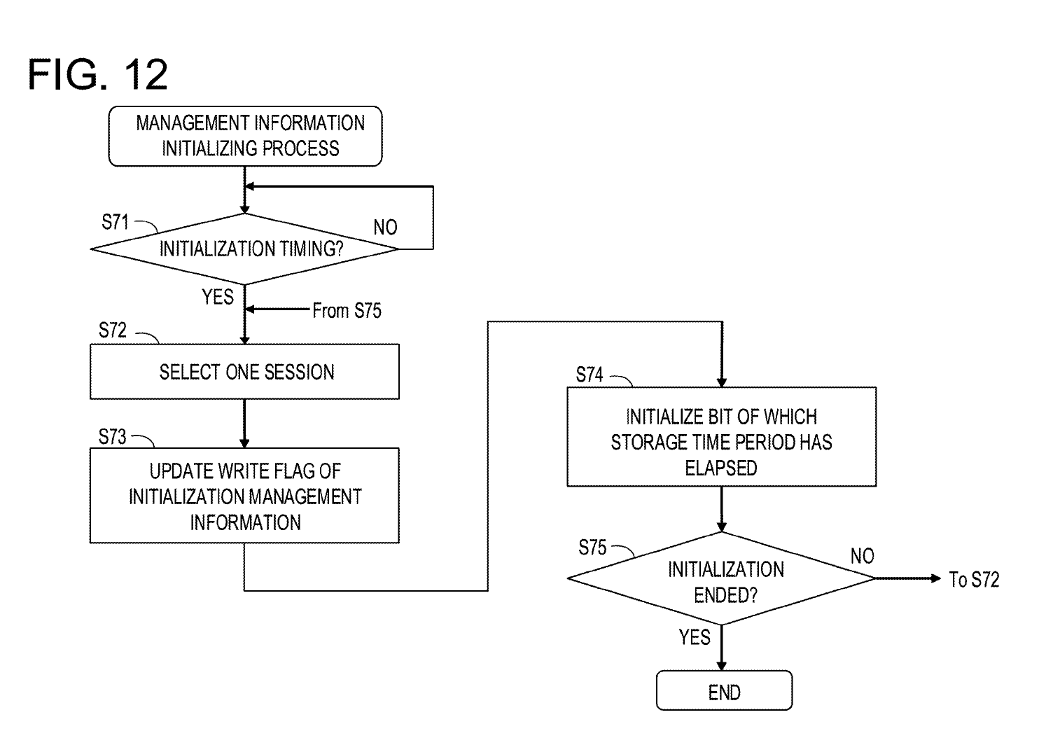

Next, in the packet detecting process, a process of initializing the first management information 332a (hereinafter, also referred-to as a “management information initializing process”) will be described. FIG. 12 is a flowchart for explaining the management information initializing process.

As illustrated in FIG. 12, the information management unit 312 waits until a timing for initializing the first management information 332a (“NO” in S71). The timing for initializing the first management information 332a may be a periodic timing such as every 1 ms.

Then, when the initialization timing comes (“YES” in S71), the information management unit 312 refers to the session information 331 stored in the information storage area 330, and selects one communication session of which information is included in the session information 331 (S72).

Subsequently, the information management unit 312 updates a “write flag” of the initialization management information 336 corresponding to the communication session selected in the process of S72, in the initialization management information 336 stored in the information storage area 330 (S73). Hereinafter, a specific example of the initialization management information 336 will be described.

<Specific Example of Initialization Management Information>

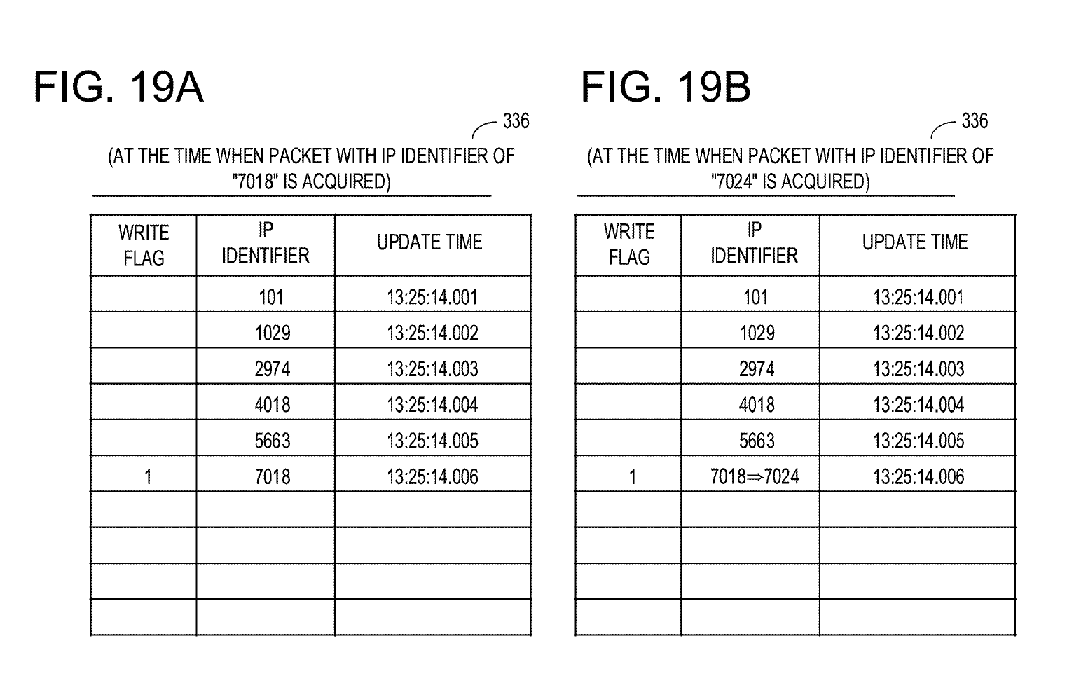

FIGS. 19A, 19B, 20A, 20B, 22A, and 22B are views illustrating a specific example of the initialization management information 336.

The initialization management information 336 illustrated in, for example, FIGS. 19A and 19B includes, as items, the “writing flag” indicating a location where an IP identifier is set (stored) in the process of S37, an “IP identifier” in which the IP identifier is set, and an “update time” indicating a time when the IP identifier is set. In the process of S37, the information management unit 312 sets the IP identifier acquired in the process of S31, in the “IP identifier” corresponding to the “write flag” in which “1” is set.

Specifically, the example illustrated in FIG. 19A represents a state where “7018” is set in the “IP identifier” corresponding to the “write flag” in which “1” is set. The example illustrated in FIG. 19B represents a state where “7024” is set in the “ID identifier” corresponding to the “write flag” in which “1” is set after the state illustrated in FIG. 19A.

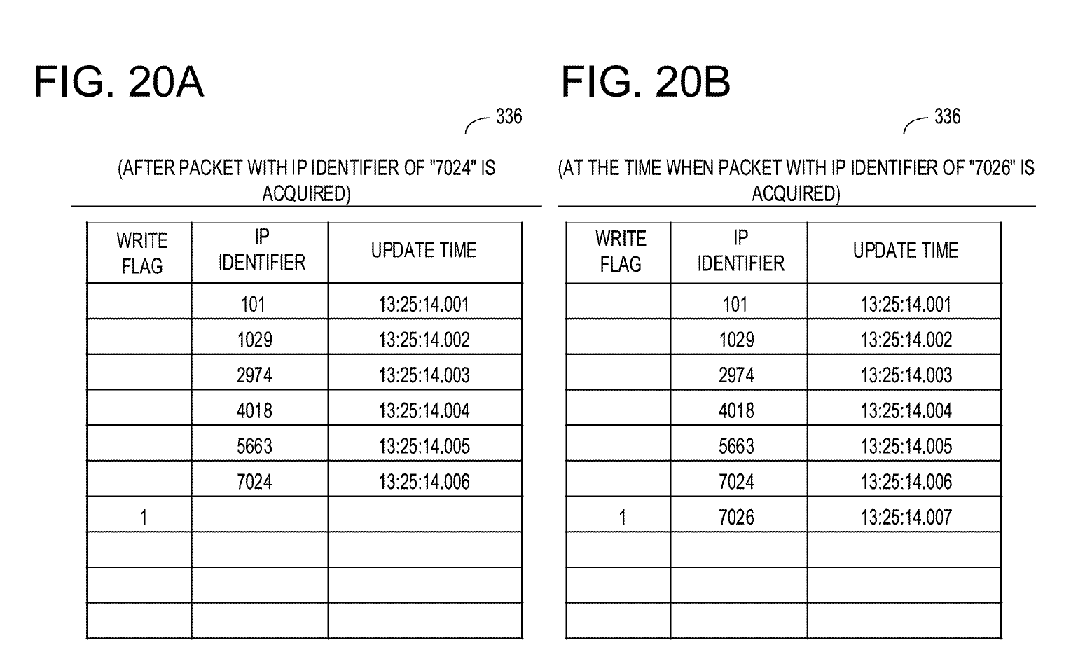

Then, when the initialization timing comes, the information management unit 312 moves “1” set in the “write flag” to the following row as illustrated in FIG. 20A (S73). Then, as illustrated in FIG. 20B, the information management unit 312 sets a newly acquired IP identifier (“7026” in the example of FIG. 20B) in the “IP identifier” corresponding to the “write flag” in which “1” is newly set. Further, for example, when the new IP identifier is set in the “IP identifier,” the information management unit 312 sets the time when the new IP identifier is stored, in the “update time.”

Referring back to FIG. 12, based on the storage time-period information 335 and the initialization management information 336 which are stored in the information storage area 330, the information management unit 312 initializes a bit of which storage time period has elapsed, among the bits included in the first management information 332a (bit strings) (S74). In addition, in this case, the information management unit 312 initializes the second management information 332b (bit string) corresponding to the bit of which the storage time period has elapsed, among the bits included in the first management information 332a. Hereinafter, a specific example of the case where the first management information 332a is initialized will be described.

<Specific Example of Case Where First Management Information Is Initialized>

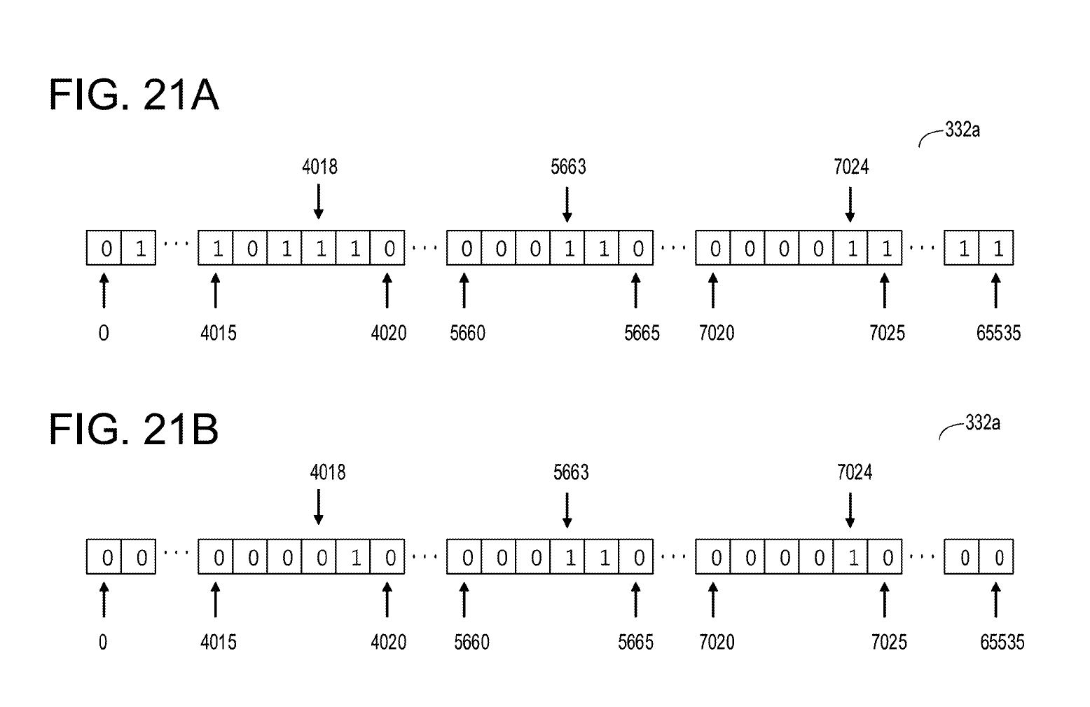

FIGS. 21A and 21B are views for explaining a specific example of the case where the first management information 332a is initialized. In the example of FIGS. 21A and 21B, a case where IP identifiers which are likely to be generated are 0 to 65535 will be described. In addition, each numeral in FIGS. 21A and 21B indicates an IP identifier corresponding to the first management information 332a stored in each bit. Hereinafter, descriptions will be made on a case where the storage time period of the first management information 332a is 2 ms.

For example, the information management unit 312 refers to the initialization management information 336 in the state illustrated in FIG. 20A, and acquires information of an IP identifier in which the storage time period of the first management information 332a elapses.

Specifically, in the example of FIG. 20A, a counting has been completed up to the counted time period in which the “update time” is “13:25:14.006.” Thus, in the example of FIG. 20A, the IP identifier in which the storage time period stored in the storage time-period information 335 has elapsed since “1” was stored in the bit included in the first management information 332a is an IP identifier corresponding to information in which a time earlier than “13:25:14.004” is set in the “update time.” Thus, in this case, the information management unit 312 determines that the maximum value of the IP identifier in which the first management information 332a needs to be initialized is “4018” which is the information set in the “IP identifier” of the information in which “13:25:14.004” is set in the “update time.”

In addition, in the example of FIG. 20A, the information set in the “IP identifier” of the information in which “13:25:14.006” corresponding to the previous counted time period is set in the “update time” is “7024.” Thus, in the example of FIG. 20A, for example, the information management unit 312 determines that the bits corresponding to the IP identifiers other than “4019” to “7024” need to be initialized.

Accordingly, in this case, the information management unit 312 updates the bit string included in the first management information 332a illustrated in FIG. 21A to become the example of the bits included in the first management information 332a illustrated in FIG. 21B.

As a result, the information management unit 312 is able to efficiently initialize the first management information 332a of which the storage time period has elapsed since “1” was stored.

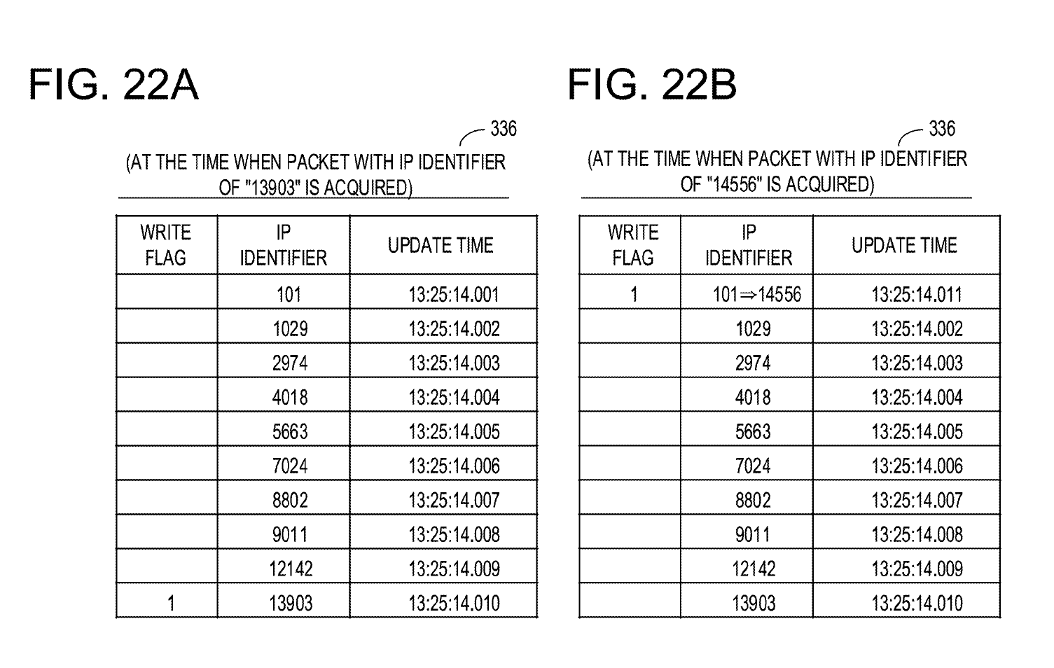

In addition, as illustrated in FIG. 22A, when information is stored in all the areas for storing the initialization management information 336, the information management unit 312 may cycle the IP identifier within the initialization management information 336. That is, in this case, as illustrated in FIG. 22B, the information management unit 312 may perform an update such that the location of the “IP identifier” indicated by the “write flag” becomes the first row.

Referring back to FIG. 12, the information management unit 312 repeats the processes of S72 to S74 until the initialization of the first management information 332a (bit strings) for all communication sessions is completed (S75).

As described above, when a communication packet is acquired, the duplicate packet detecting apparatus 3 of the present embodiment identifies a communication session in which the acquired communication packet is transmitted and received, based on the information identifying the communication session included in the header of the acquired communication packet.

Then, the duplicate packet detecting apparatus 3 refers to the memory that stores the first management information 332a indicating, for each communication session, whether a communication packet corresponding to each IP identifier has been acquired, and determines whether the first management information 332a corresponding to the identified communication session includes the first information indicating that the communication packet corresponding to the IP identifier of the acquired communication packet has been acquired.

Then, when it is determined that the first management information 332a includes the first information, the duplicate packet detecting apparatus 3 refers to the memory that stores the second management information 332b indicating, for each communication session and each IP identifier, whether a communication packet corresponding to each fragment offset has been acquired, and determines whether the second management information 332b corresponding to a combination of the identified communication session and the IP identifier of the acquired communication packet includes the second information indicating that the communication packet corresponding to the fragment offset of the acquired communication packet has been acquired.

Then, when it is determined that the second management information 332b includes the second information, the duplicate packet detecting apparatus 3 discards the acquired communication packet. When it is determined that the first management information 332a does not include the first information or the second management information 332b does not include the second information, the duplicate packet detecting apparatus adds the information indicating that the acquired communication packet has been acquired, to the first management information 332a and the second management information 332b.

That is, the duplicate packet detecting apparatus 3 holds the first management information 332a indicating, for each communication session, whether a communication packet corresponding to each IP identifier has been acquired, and the second management information 332b indicating, for each communication session and each IP identifier, whether a communication packet corresponding to each fragment offset has been acquired. Then, when a new communication packet is acquired, the duplicate packet detecting apparatus 3 refers to the first management information 332a and the second management information 332b, and determines whether a communication packet which is identical to the new communication packet in IP identifier and fragment offset has been acquired, in the same communication session as that of the new communication packet. As a result, when it is determined that a communication packet which is identical to the new communication packet in IP identifier and fragment offset has been acquired, the duplicate packet detecting apparatus 3 determines that the new communication packet is a duplicate packet, and discards the duplicate packet.

Accordingly, when a new communication packet is acquired, the duplicate packet detecting apparatus 3 is able to check the duplication of the new communication packet by referring to the first management information 332a and the second management information 332b which correspond to the new communication packet. Thus, when the duplication of the new communication packet is checked, the duplicate packet detecting apparatus 3 does not need to match the new communication packet and a communication packet acquired in the past with each other. Accordingly, the duplicate packet detecting apparatus 3 may reduce the process burden of, for example, the CPU at the time of checking the duplication of a communication packet.

In addition, the duplicate packet detecting apparatus 3 performs the duplication check by referring to the first management information 332a and the second management information 332b, so that the duplicate packet detecting apparatus 3 does not need to save all of communication packets acquired in the past. Thus, the duplicate packet detecting apparatus 3 may reduce the storage areas of the communication packets acquired in the past.

Further, the duplicate packet detecting apparatus 3 refers to not only the first management information 332a but also the second management information 332b to perform the duplication check. Thus, even when communication packets flowing through the network NW are divided according to a maximum transmission unit (MTU) of the network NW so that there exist multiple communication packets having the same IP identifier, the duplication of the communication packets may be checked.

<Outline of Second Embodiment>

Next, the outline of a second embodiment will be described.

In the first embodiment, the second storage location information 333b is generated by associating each of all the bits included in the first management information 332a (bit strings) with the second management information 332b corresponding to each bit. Meanwhile, according to the second embodiment, the second storage location information 333b is generated by only associating a group of multiple bits included in the first management information 332a (hereinafter, also referred-to as a “bit group”) and a group of multiple pieces of second management information 332b corresponding to the bit group (hereinafter, also referred-to as a “second management information group”).

As a result, the duplicate packet detecting apparatus 3 may reduce the storage areas of the second storage location information 333b.

<Details of Second Embodiment>

Next, the outline of the second embodiment will be described.

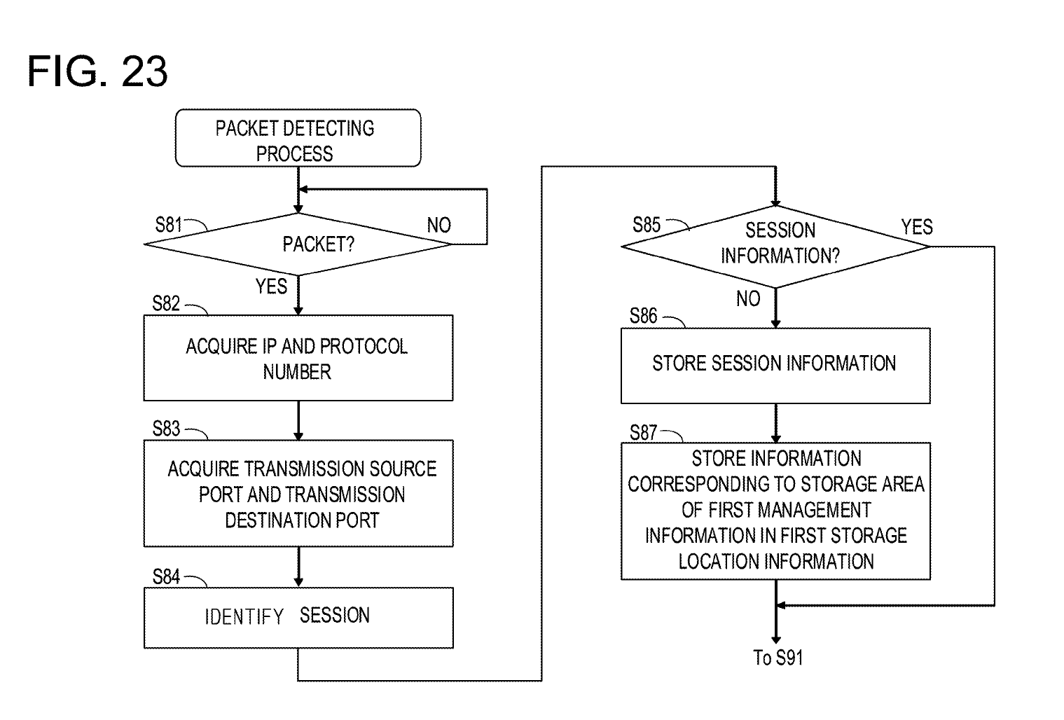

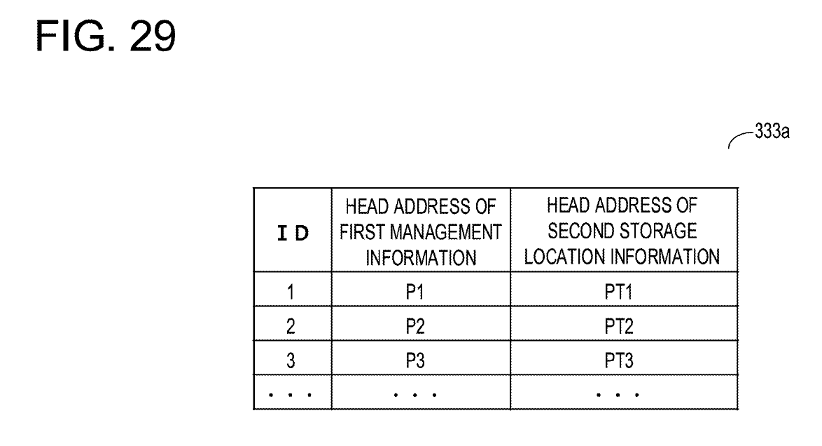

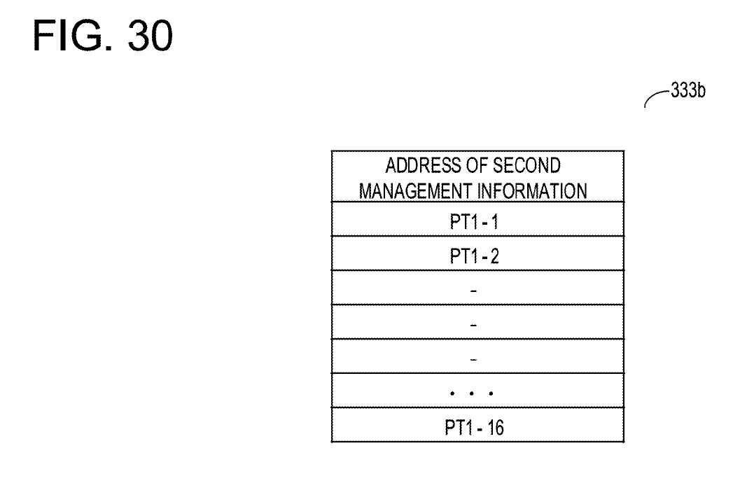

FIGS. 23 to 28 are flowcharts for explaining the outline of the packet detecting process according to the second embodiment. In addition, FIGS. 29 to 30 are views for explaining specific examples of various pieces of information in the packet detecting process of the second embodiment. Referring to FIGS. 29 to 30, the details of the packet detecting process illustrated in FIGS. 23 to 28 will be described.

As illustrated in FIG. 23, the packet acquisition unit 311 waits until a communication packet is acquired from the capturing points (“NO” in S81).

Then, when a communication packet is acquired (“YES” in S81), the packet acquisition unit 311 acquires information for identifying a communication session including the acquired communication packet (S82 and S83). Specifically, in this case, the packet acquisition unit 311 acquires a transmission source IP, a transmission destination IP, and a protocol number from the IP header of the acquired communication packet (S82). Further, in this case, the packet acquisition unit 311 acquires a transmission source port and a transmission destination port from the TCP header of the acquired packet (S83).

Then, the information management unit 312 identifies a communication session including the communication packet acquired in the process of S81, based on the information acquired in the processes of S82 and S83 (S84).

Subsequently, for example, the information management unit 312 confirms whether the session information 331 on the communication session identified in the process of S84 is stored in the information storage area 330 (S85). When it is determined that the session information 331 is not stored (“NO” in S85), for example, the information management unit 312 stores the session information 331 indicating the communication session including the communication packet acquired in S81 in the information storage area 330, based on the information acquired in the processes of S82 and S83 (S86).

In addition, in this case, the information management unit 312 secures a storage area for storing the first management information 332a (bit string) corresponding to the communication session including the communication packet acquired in the process of S81, and stores the information corresponding to the secured storage area in the first storage location information 333a (S87).

Meanwhile, when it is determined in the process of S85 that the session information 331 is stored (“YES” in S85), the information management unit 312 does not perform the processes of S86 and S87.

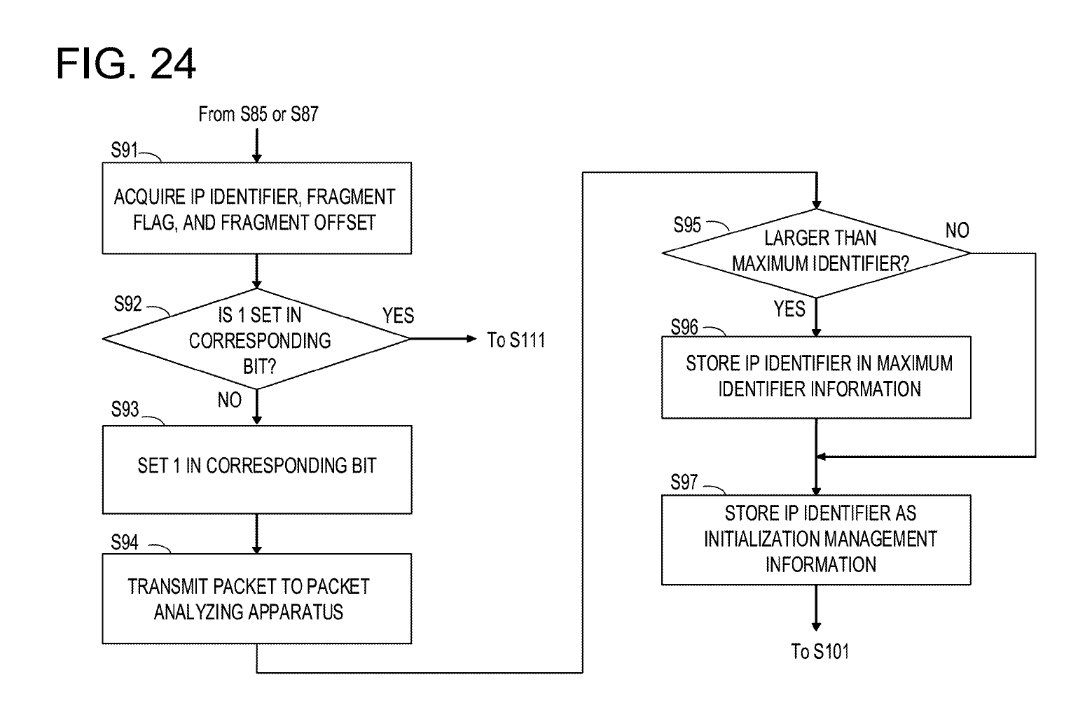

Subsequently, as illustrated in FIG. 24, the information management unit 312 acquires each of an IP identifier, a fragment flag, and a fragment offset included in the IP header of the communication packet acquired in the process of S81 (S91).

Then, the packet transmission unit 314 determines whether “1” is set in the bit corresponding to the IP identifier acquired in the process of S91, among the bits included in the first management information 332a (bit string) stored in the information storage area 330 (S92).

As a result, when it is determined that “0” is stored in the bit corresponding to the IP identifier acquired in the process of S91 (“NO” in S92), the information management unit 312 stores “1” in the bit corresponding to the IP identifier acquired in the process of S91, among the bits included in the first management information 332a stored in the information storage area 130 (S93).

Then, for example, the packet transmission unit 314 transmits the communication packet acquired by the packet acquisition unit 311 to the packet analyzing apparatus 5 (S94).

In addition, when it is determined that the IP identifier acquired in the process of S91 is larger than the value corresponding to the maximum identifier information 334 (“YES” in S95), the information management unit 312 stores the IP identifier acquired in the process of S91 as the maximum identifier information 334 in the information storage area 330 (S96).

In addition, when it is determined that the IP identifier acquired in the process of S91 is equal to or smaller than the value corresponding to the maximum identifier information 334 stored in the information storage area 330 (“NO” in S95), the information management unit 312 does not perform the process of S96.

Then, the information management unit 312 stores the IP identifier acquired in the process of S91 as the initialization management information 336 in the information storage area 330 (S97).

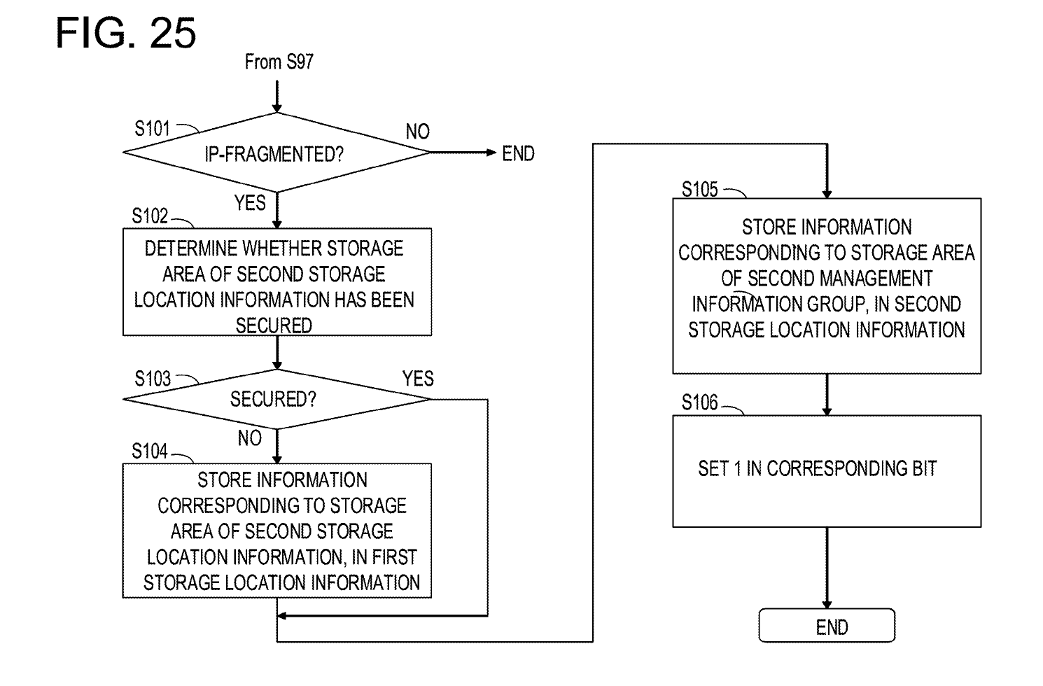

Subsequently, as illustrated in FIG. 25, when it is determined that the communication packet acquired by the process of S81 is an IP-fragmented communication packet (“YES” in S101), the information management unit 312 determines whether the storage area of the second storage location information 333b corresponding to the communication session identified in the process of S84 is secured (S102).

As a result, when it is determined that the storage area of the second storage location information 333b is not secured (“NO” in S103), the information management unit 312 secures the storage area of the second storage location information 333b corresponding to the communication session identified in the process of S84, and stores the information corresponding to the secured area in the first storage location information 333a (S104). The specific examples of the first storage location information 333a and the second storage location information 333b according to the second embodiment will be described later.

In addition, when it is determined that the storage area of the second storage location information 333b is secured (“YES” in S103), the information management unit 312 does not perform the process of S104.

Then, the information management unit 312 secures a storage area of a second management information group corresponding to the head address that stores the second management information group (multiple bit strings) including the second management information 332b corresponding to the fragment offset acquired in the process of S91, and stores the information corresponding to the secured area in the second storage location information 333b (S105).

That is, in the packet detecting process according to the second embodiment, the storage area is secured collectively for each second management information group including multiple pieces of second management information 332b.

Then, the information management unit 312 stores “1” in the bit corresponding to the fragment offset acquired in the process of S91, among the bits included in the second management information 332b (bit strings) of which storage area has been secured in the process of S105 (S106). Then, the duplicate packet detecting apparatus 3 ends the packet detecting process.

In addition, when it is determined that the communication packet acquired in the process of S81 is not an IP-fragmented packet (“YES” in S101), the information management unit 312 does not perform the processes of S102 to S106.

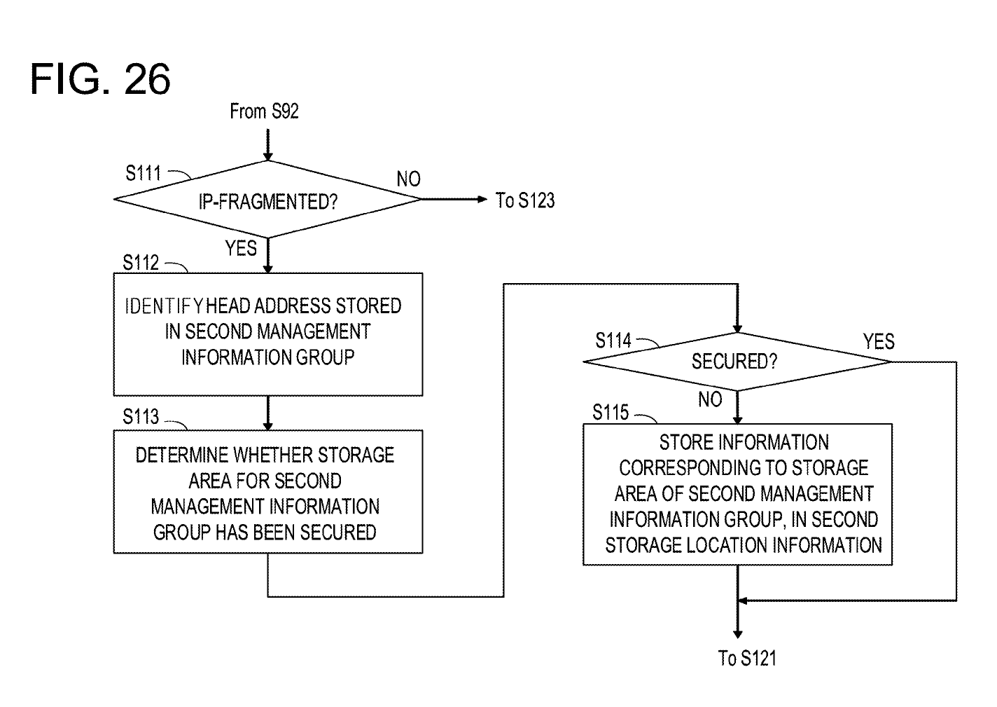

When it is determined that “1” is stored in the bit corresponding to the IP identifier acquired in the process of S91 (“YES” in S92), the information management unit 312 determines whether the communication packet acquired in the process of S81 is an IP-fragmented packet, as illustrated in FIG. 26 (S111).

As a result, when it is determined that the communication packet acquired in the process of S81 is an IP-fragmented packet (“YES” in S111), the information management unit 312 identifies a head address stored in a second management information group (multiple bit strings) including the second management information 332b corresponding to the fragment offset acquired in the process of S91 (S112).

Specifically, for example, the information management unit 312 may refer to association information (not illustrated) in which each second management information 332b and the head address of the second management information group including each second management information 332b are associated with each other, and identify the head address that stores the second management information group including the second management information 332b corresponding to the fragment offset acquired in the process of S91.

Then, the information management unit 312 determines whether a storage area for storing the second management information group corresponding to the head address identified in the process of S112 is secured (S113).

As a result, when it is determined that a storage area for storing the second management information group corresponding to the head address identified in the process of S112 is not secured (“NO” in S114), the information management unit 312 secures the storage area of the second management information group corresponding to the head address identified in the processes of S112, and stores the information corresponding to the secured area in the second storage location information 333b (S115).

Meanwhile, when it is determined that the storage area for storing the second management information group corresponding to the head address identified in the process of S112 is secured (“YES” in S114), the information management unit 312 does not perform the processes of S112 and S115. Hereinafter, a specific example of the storage location information 333 according to the second embodiment will be described.

<Specific Example of Storage Location Information>

FIGS. 29 and 30 are views for explaining a specific example of the storage location information 333 according to the second embodiment. Specifically, FIG. 29 is a view for explaining a specific example of the first storage location information 333a. FIG. 30 is a view for explaining a specific example of the second storage location information 333b.

First, the specific example of the first storage location information 333a will be described.

The first storage position information 333a illustrated in FIG. 29 has the same items as those in the first storage location information 333a described in FIG. 17. Specifically, for the information with the “ID” of “1” in the first storage location information 333a illustrated in FIG. 29, “P1” is set as the “head address of first management information,” and “PT1” is set as the “head address of second storage location information.” In addition, for the information with the “ID” of “2” in the first storage location information 333a illustrated in FIG. 29, “P2” is set as the “head address of first management information,” and “PT2” is set as the “head address of second storage location information.” The descriptions of the other information included in FIG. 29 will be omitted.

Subsequently, a specific example of the second storage location information 333b will be described. Specifically, FIG. 30 is a view for explaining a specific example of the second storage location information 333b corresponding to the communication session with the “ID” of “1” in the second storage location information 333b. That is, the head address of the second storage location information 333b illustrated in FIG. 30 is “PT1” which is set in the “head address of second storage location information” of the information with the “ID” of “1” in the first storage location information 333a illustrated in FIG. 29.

The second storage position information 333b illustrated in FIG. 30 has the same items as those in the second storage position information 333b described in FIG. 17. In the second storage position information 333b illustrated in FIG. 30, the head address of the second management information group is set in each row of the “address of second management information.” In addition, for example, in a case where types of values which are likely to be set as IP identifiers of a communication packet are 65536, when the second management information group includes 4096 pieces of second management information 332b (bit strings), the number of second management information groups corresponding to each communication session is 16 which is a value obtained by dividing 65536 by 4096. Thus, the second storage location information 333b illustrated in FIG. 30 includes 16 rows.

Specifically, in the second storage location information 333b illustrated in FIG. 30, “PT1-1” is set in the first row from the top, “PT1-2” is set in the second row from the top, and “-” is set in the third row from the top.

That is, in the second storage location information 333b illustrated in FIG. 30, the information is set which indicates that the head address of the second management information group including the second management information 332b corresponding to the communication packets with the IP identifiers of “0” to “4095” is “PT1-1.” Further, in the second storage location information 333b illustrated in FIG. 30, the information is set which indicates that the head address of the second management information group including the second management information 332b corresponding to the communication packets with the IP identifiers of “4096” to “8191” is “PT1-1.” Further, in the second storage location information 333b illustrated in FIG. 30, the information is set which indicates that the storage area of the second management information group including the second management information 332b corresponding to the communication packets with the IP identifiers of “8192” to “12287” has not yet been secured. The descriptions of the other information illustrated in FIG. 30 will be omitted.

That is, the information management unit 312 collectively performs the process of securing a storage area and the process of storing information corresponding to the second storage location information 333b (the process of S105), for each second management information 332b included in the second management information group.

As a result, the duplicate packet detecting apparatus 3 according to the second embodiment may reduce the storage areas of the second storage location information 333b. In addition, the duplicate packet detecting apparatus 3 may further suppress the process burden accompanied by the duplication check of a communication packet.

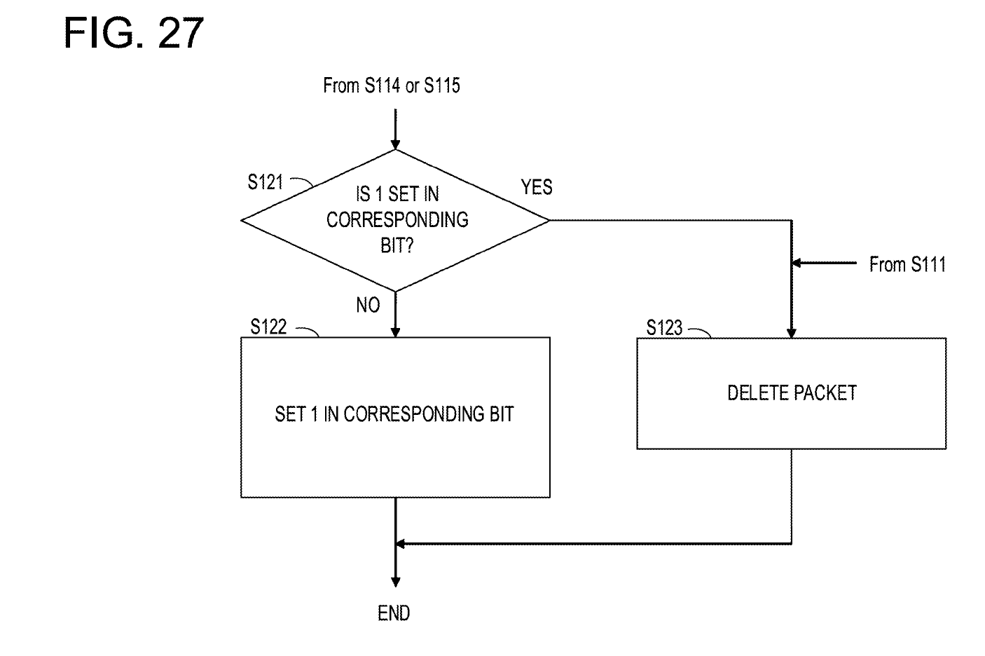

Referring back to FIG. 27, for example, the packet determination unit 313 determines whether “1” is set in the bit corresponding to the fragment offset acquired in the process of S91, among the bits included in the second management information 332b (bit strings) stored in the information storage area 330 (S121).

As a result, when it is determined that “0” is stored in the bit corresponding to the fragment offset acquired in the process of S91 (“NO” in S121), the information management unit 312 stores “1” in the bit corresponding to the fragment offset acquired in the process of S91 (S122).

Meanwhile, when it is determined that “1” is stored in the bit corresponding to the fragment offset acquired in the process of S91 (“YES” in S121), the packet discarding unit 315 deletes the communication packet acquired in the process of S81 (S123).

In addition, when it is determined that the communication packet acquired in the process of S81 is not an IP-fragmented packet (“NO” of S111), the packet discarding unit 315 also deletes the communication packet acquired in S81 (S123).

Then, after the process of S122 or S123, the duplicate packet detecting apparatus 3 ends the packet detecting process.

<Management Information Initializing Process>

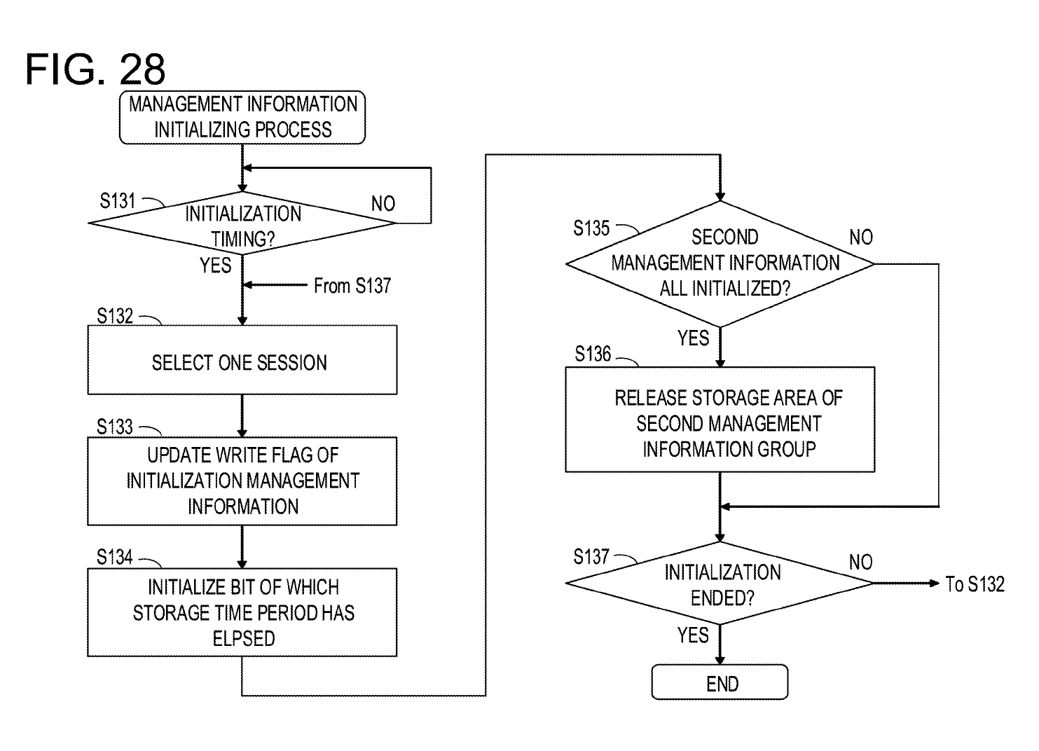

Next, the management information initializing process according to the second embodiment will be described. FIG. 28 is a flowchart for explaining the management information initializing process.

As illustrated in FIG. 28, the information management unit 312 waits until a timing for initializing the first management information 332a (“NO” in S131).

Then, when the initialization timing comes (“YES” in S131), the information management unit 312 refers to the session information 331 stored in the information storage area 330, and selects one communication session of which information is included in the session information 331 (S132).

Subsequently, the information management unit 312 updates the “write flag” of the initialization management information 336 (S133).

Then, based on the storage time-period information 335 and the initialization management information 336, the information management unit 312 initializes a bit of which storage time period has elapsed, among the bits included in the first management information 332a (bit strings) (S134).

Then, the information management unit 312 determines whether there exists the second management information group in which all of the included pieces of second management information 332b (bit strings) are initialized (S135).

As a result, when it is determined that there exists the second management information group in which all of the pieces of second management information 332b are initialized (“YES” in S135), the information management unit 312 releases the storage area of the second management information group in which all of the pieces of second management information 332b are determined to have been initialized (S136).

Meanwhile, when it is determined that there exists no second management information group in which all of the pieces of second management information 332b are initialized (“NO” in S135), the information management unit 312 does not perform the process of S136.

Then, for example, the information management unit 312 repeats the processes of S132 to S136 until the initialization of the bit strings of the first management information 332a for all of the communication sessions is completed (S137).

That is, in the packet detecting process according to the second embodiment, the storage area of the second management information group which does not need to be managed is frequently released.

As a result, the duplicate packet detecting apparatus 3 may further reduce the storage areas of the second management information 333b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
identifying, upon acquiring a communication packet, a communication session in which the acquired communication packet is transmitted and received, based on information included in a header of the acquired communication packet;
referring to a first memory that stores, for each communication session, first management information indicating whether a communication packet corresponding to a packet identifier has been acquired;
determining whether the first management information includes first acquisition information indicating that a communication packet corresponding to a packet identifier included in a header of the acquired communication packet has been acquired;
referring, upon determining that the first management information includes the first acquisition information, to a second memory that stores, for each combination of a communication session and a packet identifier, second management information indicating whether a communication packet corresponding to a fragment offset has been acquired;
determining whether the second management information includes second acquisition information indicating that a communication packet corresponding to a fragment offset included in a header of the acquired communication packet has been acquired;
discarding the acquired communication packet upon determining that the second management information includes the second acquisition information; and
adding acquisition information indicating that the acquired communication packet has been acquired to the first management information and the second management information upon determining that the first management information does not include the first acquisition information or upon determining that the second management information does not include the second acquisition information.

2. The non-transitory computer-readable recording medium according to claim 1, wherein
the first management information includes a first bit string corresponding to each communication session,
the second management information includes a second bit string corresponding to each combination of a communication session and a packet identifier, and
the process further comprises:
determining whether information indicating that a communication packet has been acquired is set in a bit corresponding to the packet identifier of the acquired communication packet in the first bit string corresponding to the identified communication session, so as to determine whether the first management information includes the first acquisition information; and
determining whether information indicating that a communication packet has been acquired is set in a bit corresponding to the fragment offset of the acquired communication packet in the second bit string corresponding to the combination of the identified communication session and the packet identifier of the acquired communication packet, so as to determine whether the second management information includes the second acquisition information.

3. The non-transitory computer-readable recording medium according to claim 1, the process further comprising:
referring to a third memory that stores association information in which an address of the first management information for each communication session and an address of the second management information for each combination of a communication session and a packet identifier are associated with each other; and
identifying an address corresponding to the packet identifier of the acquired communication packet, among addresses of the second management information corresponding to the address of the first management information for the identified communication session, as an address of the second management information for a combination of the identified communication session and the packet identifier of the acquired communication packet, so as to determine whether the second management information includes the second acquisition information.

4. The non-transitory computer-readable recording medium according to claim 3, wherein
the association information is information that associates an address of the first management information for each communication session with consecutive addresses corresponding to a predetermined number of packet identifiers, among addresses of the second management information for each communication session, and
the process further comprises:
identifying addresses corresponding to the predetermined number of packet identifiers including the packet identifier of the acquired communication packet, among the addresses of the second management information corresponding to the address of the first management information for the identified communication session; and
identifying an address corresponding to the packet identifier of the acquired communication packet, among the identified addresses, as the address of the second management information for the combination of the identified communication session and the packet identifier of the acquired communication packet.

5. The non-transitory computer-readable recording medium according to claim 2, wherein
a packet identifier is assigned to each of communication packets in an order in which the communication packets are transmitted, and
the process further comprises:
setting in the first bit string, when the packet identifier of the acquired communication packet has been cycled, acquisition information indicating that a communication packet has not been acquired in first bits corresponding to a predetermined number of packet identifiers from a top of packet identifiers, and
setting in the first bit string, when the packet identifier of the acquired communication packet reaches a packet identifier corresponding to a bit of the first management information other than the first bits, acquisition information indicating that a communication packet has not been acquired, in second bits corresponding to the predetermined number of packet identifiers subsequent to the packet identifiers corresponding to the first bits.

6. The non-transitory computer-readable recording medium according to claim 2, the process further comprising:
setting acquisition information indicating that a communication packet has not been acquired in a bit of the first bit string when a predetermined time has elapsed since the acquisition information indicating that a communication packet has been acquired is set in the bit.

7. An information processing apparatus, comprising:
a first memory configured to store, for each communication session, first management information indicating whether a communication packet corresponding to a packet identifier has been acquired;
a second memory configured to store, for each combination of a communication session and a packet identifier, second management information indicating whether a communication packet corresponding to a fragment offset has been acquired; and
a processor coupled to the first and second memories and the processor configured to:
identify, upon acquiring a communication packet, a communication session in which the acquired communication packet is transmitted and received, based on information included in a header of the acquired communication packet;
determine whether the first management information stored in the first memory includes first acquisition information indicating that a communication packet corresponding to a packet identifier included in a header of the acquired communication packet has been acquired;
determine, upon determining that the first management information includes the first acquisition information, whether the second management information stored in the second memory includes second acquisition information indicating that a communication packet corresponding to a fragment offset included in a header of the acquired communication packet has been acquired;
discard the acquired communication packet upon determining that the second management information includes the second acquisition information; and
add acquisition information indicating that the acquired communication packet has been acquired to the first management information and the second management information upon determining that the first management information does not include the first acquisition information or upon determining that the second management information does not include the second acquisition information.

8. The information processing apparatus according to claim 7, wherein
the first management information includes a first bit string corresponding to each communication session,

9. A method of detecting a packet, the method comprising:
identifying by a computer, upon acquiring a communication packet, a communication session in which the acquired communication packet is transmitted and received, based on information included in a header of the acquired communication packet;
referring to a first memory that stores, for each communication session, first management information indicating whether a communication packet corresponding to a packet identifier has been acquired;
determining whether the first management information includes first acquisition information indicating that a communication packet corresponding to a packet identifier included in a header of the acquired communication packet has been acquired;
referring, upon determining that the first management information includes the first acquisition information, to a second memory that stores, for each combination of a communication session and a packet identifier, second management information indicating whether a communication packet corresponding to a fragment offset has been acquired;
determining whether the second management information includes second acquisition information indicating that a communication packet corresponding to a fragment offset included in a header of the acquired communication packet has been acquired;
discarding the acquired communication packet upon determining that the second management information includes the second acquisition information; and
adding acquisition information indicating that the acquired communication packet has been acquired to the first management information and the second management information upon determining that the first management information does not include the first acquisition information or upon determining that the second management information does not include the second acquisition information.

10. The method according to claim 9, wherein
the first management information includes a first bit string corresponding to each communication session,
the second management information includes a second bit string corresponding to each combination of a communication session and a packet identifier, and
the process further comprises:
determining whether information indicating that a communication packet has been acquired is set in a bit corresponding to the packet identifier of the acquired communication packet in the first bit string corresponding to the identified communication session, so as to determine whether the first management information includes the first acquisition information; and
determining whether information indicating that a communication packet has been acquired is set in a bit corresponding to the fragment offset of the acquired communication packet in the second bit string corresponding to the combination of the identified communication session and the packet identifier of the acquired communication packet, so as to determine whether the second management information includes the second acquisition information.
